(19) United States
(12) Patent Application Publication
(10) Pub. No.: US 2026/0230302 A1
(43) Pub. Date: Aug. 6, 2026

(54) SECURING IKEV2 WITH KEY DERIVATION FUNCTION: A ROBUST APPROACH TO PSK AUTHENTICATION

(71) Applicant: Palo Alto Networks, Inc., Santa Clara, CA (US)

(72) Inventors: Madhusudhan Gopalappa, San Jose, CA (US); Xin Yao, San Jose, CA (US); Mohit Sahni, Fremont, CA (US)

(21) Appl. No.: 19/042,608

(22) Filed: Jan. 31, 2025

(51) Int. Cl. H04L 9/08

(52) U.S. Cl. CPC H04L 9/0819; H04L 9/0869; H04L 9/0891

(57) ABSTRACT

The present application discloses a method, system, and computer system for performing an Internet Key Exchange version 2 (IKEv2) authentication. The method includes (i) generating a pre-shared key (PSK) based at least in part on a master key and a random cryptographic salt using a key derivation function (KDF), and (ii) validating an endpoint based at least in part on using the PSK. The validation of the endpoint is based at least in part on a determination that the endpoint has previously authenticated with credentials.

### BACKGROUND OF THE INVENTION

Internet Key Exchange version 2(IKEv2 ) is widely used as a protocol for negotiating and establishing secure communication channels, especially in virtual private networks (VPNs) and enterprise network environments. However, traditional implementations rely heavily on fixed credentials or static cryptographic keys, which can become points of vulnerability if compromised. Additionally, session management in many existing systems is insecure, potentially allowing unauthorized access through stolen or replayed credentials.

### BRIEF DESCRIPTION OF THE DRAWINGS

Various embodiments of the invention are disclosed in the following detailed description and the accompanying drawings.

FIG. 1 is a block diagram of an environment for providing a security service to a network according to various embodiments.

FIG. 2 is a block diagram of a system for providing access to network resources according to various embodiments.

FIG. 3 is a block diagram of a system for providing access to network resources according to various embodiments.

FIG. 4 is a flow diagram of a method for validating an endpoint according to various embodiments.

FIG. 5 is a flow diagram of a method for validating an endpoint according to various embodiments.

FIG. 6 is a flow diagram of a method for obtaining a pre-shared key (PSK) for an endpoint according to various embodiments.

FIG. 7 is a flow diagram of a method for obtaining a PSK for an endpoint according to various embodiments.

FIG. 8 is a flow diagram of a method for obtaining a PSK according to various embodiments.

FIG. 9 is a flow diagram of a method for obtaining a PSK according to various embodiments.

FIG. 10 is a flow diagram of a method for validating an endpoint in connection with an Internet Key Exchange version 2(IKEv2 ) authentication according to various embodiments.

FIG. 11 is a flow diagram of a method for validating an endpoint in connection with an IKEv2 authentication according to various embodiments.

FIG. 12 is a flow diagram of a method for providing a PSK to an endpoint according to various embodiments.

FIG. 13 is a flow diagram of a method for obtaining a PSK to validate an endpoint in connection with an IKEv2 authentication according to various embodiments.

FIG. 14 is a flow diagram of a method for obtaining a new PSK according to various embodiments.

FIG. 15 is a flow diagram of a method for obtaining a new PSK according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a security entity may be a network node (e.g., a device) that enforces one or more security policies with respect to information such as network traffic, files, etc. As an example, a security entity may be a firewall. As another example, a security entity may be implemented as a router, a switch, a DNS resolver, a computer, a tablet, a laptop, a smartphone, etc. Various other devices may be implemented as a security entity. As another example, a security entity may be implemented as an application running on a device, such as an anti-malware application.

Session management in many existing systems does not adequately ensure that authentication mechanisms are tied to specific sessions, potentially allowing unauthorized access through stolen or replayed credentials. To overcome these limitations, various embodiments implement dynamic key generation and session-specific authentication, creating a highly resilient authentication framework.

Various embodiments provide a system and method for securing network access through an enhanced Internet Key Exchange Version 2 (IKEv2) authentication mechanism. In modern enterprise networks, safeguarding sensitive resources and assets is paramount as organizations face increasingly sophisticated cyber threats. Conventional authentication methods, while effective in certain scenarios, often fall short of addressing advanced security challenges such as session-specific credential validation, cryptographic robustness, and resistance to unauthorized access attempts. The techniques and/or mechanisms described herein address these challenges by introducing a system that combines the use of a pre-shared key (PSK) and a session authentication cookie to establish a more secure and reliable IKEv2 authentication process.

Various embodiments provide a method, system, and computer system for performing an Internet Key Exchange version 2 (IKEv2) authentication. The method includes (i) generating a pre-shared key (PSK) based at least in part on a master key and a random cryptographic salt using a key derivation function (KDF), and (ii) validating an endpoint based at least in part on using the PSK. The validation of the endpoint is based at least in part on a determination that the endpoint has previously authenticated with credentials.

In some embodiments, the system leverages a PSK that is generated dynamically for each session, ensuring that encryption keys remain unique and valid only within the context of a specific session. The system also integrates a session authentication cookie, which is a unique identifier assigned to an endpoint upon successful login using valid user credentials. The session authentication cookie is securely transmitted to the endpoint and associated with the session, enabling the system to validate authentication requests in a manner that is both session-aware and resistant to replay attacks. This dual-layered approach enhances security by requiring endpoints to present both the encrypted payload and a valid session cookie during authentication.

Various embodiments address the needs of enterprises that demand robust security solutions for protecting their networks and resources. The system ensures that access is granted only to authenticated and authorized endpoints while maintaining the flexibility and scalability required for dynamic and high-volume network environments. By dynamically generating cryptographic keys and tying authentication to session-specific cookies, the system can provide an advanced solution to the challenges of securing enterprise networks against evolving threats. Additionally, the system's design is compatible with existing IKEv2 protocols, making it a versatile enhancement for both current and future network security architectures.

In previous implementations of IKEv2 authentication, the authentication process typically relied on pre-shared keys (PSKs) or digital certificates to authenticate endpoints. For systems using PSKs, the administrator manually created or configured the PSK, which was then shared between the endpoints and the authentication system. This PSK served as the foundation for encrypting and validating communication, ensuring that only parties with the correct PSK could establish secure connections. While conceptually straightforward, this traditional approach introduced significant security vulnerabilities, particularly in the generation, distribution, and management of PSKs.

The process of generating PSKs in prior systems was often susceptible to human error or poor security practices. Administrators tasked with creating PSKs frequently relied on simple, predictable passphrases or passwords that were easy to remember but inherently insecure. Commonly used passwords or easily guessable phrases made these PSKs vulnerable to brute force or dictionary attacks, where malicious actors attempt to gain access by systematically guessing potential keys. This weakness was exacerbated in environments where security training or awareness among administrators was insufficient, leading to the widespread use of weak or repeated keys across multiple endpoints.

Another critical vulnerability in traditional IKEv2 authentication arose from the insecure distribution of PSKs. Administrators often shared the keys with users or endpoints through insecure communication channels such as email, text messages, or printed documents. These methods provided potential interception points for attackers who could eavesdrop on the communication or obtain the PSK through physical or digital means. Once compromised, a PSK allowed unauthorized access to network resources, often without detection, as there were no mechanisms to tie the key to a specific session or endpoint. Furthermore, static PSKs, once distributed, remained valid indefinitely unless manually updated, increasing the likelihood of misuse if an endpoint was lost or compromised.

The lack of session-specific authentication in related art systems further compounded the security challenges in traditional systems. A single PSK could be reused across multiple sessions or endpoints, making it difficult to track or isolate individual connections. This opened the door to replay attacks, where an attacker could use a previously captured PSK to gain unauthorized access without needing to know additional session details. The absence of a robust mechanism for revoking or renewing compromised keys in a timely manner further undermined the overall security of the system.

Overall, these vulnerabilities in related art authentication systems (e.g., other IKEv2 authentication systems) highlight the critical need for a more secure and dynamic approach to key management and authentication.

Various embodiments relate to an advanced system designed to enhance the security and efficiency of IKEv2 authentication processes. The system employs a combination of a PSK and a session authentication cookie to authenticate an endpoint seeking access to a network or its resources. The system ensures that only authorized endpoints are granted access by validating critical elements within the authentication request, thereby bolstering the security framework of enterprise networks.

In some embodiments, the authentication process begins when the system receives an IKEv2 authentication request from an endpoint. The authentication request contains a payload encrypted using a PSK. As an example, the payload comprised int eh authentication request comprises the session authentication cookie. In some embodiments, on the server side, the system utilizes a securely stored PSK to decrypt the payload. In some embodiments, on the server side, the system utilizes a PSK to decrypt the payload, where the PSK is obtained based at least in part on securely stored PSK information (e.g., a master key, a cryptographic salt, etc.). For example, the PSK is generated (e.g., re-generated) based on the PSK information. Upon successful decryption, the system extracts a session authentication cookie from the payload. The extracted cookie is validated by comparing it with a server-stored session authentication cookie associated with the endpoint or a specific session between the endpoint and the system. The validation process includes ensuring that the session authentication cookie is unexpired and matches the stored reference. If both the PSK decryption and cookie validation are successful, the endpoint is authenticated, and the system grants access to the requested network resources or assets. Otherwise, the authentication attempt fails, preventing unauthorized access.

In some embodiments, the session authentication cookie plays an important role for authentication of an endpoint in this system. The session authentication cookie is initially assigned to an endpoint during a login process. Upon receiving and validating the endpoint's login credentials (e.g., a username and password/passcode, etc.), the system generates and assigns a session-specific authentication cookie. This session authentication cookie is securely stored on the server side and shared with the endpoint as part of the login response, for example, over a secure connection. The session authentication cookie is unique to a particular session and is regenerated whenever a new session is initiated by the endpoint. This ensures that each session is uniquely identifiable and secure.

The PSK is another important component of the authentication mechanism. The PSK is dynamically generated by the system in response to a configuration request (e.g., a getconfig request) from the endpoint. The system creates the PSK using a master key and a cryptographic salt, providing it securely to the endpoint within the configuration response. When the endpoint initiates IKEv2 authentication, it utilizes the PSK to encrypt the payload that includes the session authentication cookie. This multi-layered approach (e.g., combining dynamic PSK generation with session-specific authentication cookies) enhances the robustness and security of the authentication process.

According to various embodiments, if the system determines that the cryptographic salt associated with an endpoint is invalid (e.g., that the cryptographic salt has expired), it takes immediate/pro-active action to maintain the security and integrity of the authentication process by invalidating the corresponding PSK that was generated using the compromised cryptographic salt. This ensures that the endpoint can no longer use the outdated or potentially compromised PSK to access network resources. In response, the system initiates the process of generating a new cryptographic salt and PSK to replace the invalid credentials. Additionally, the system can prompt the endpoint to reauthenticate by requiring it to provide valid user credentials, such as a username and password. Once the reauthentication process is completed, the system generates (e.g., in response to receiving a new getconfig request from the endpoint) a new cryptographic salt and PSK, establishing a fresh session between the endpoint and the gateway to restore secure communication.

In some implementations, the cryptographic salt is designed to have a predefined expiration period, ensuring that it remains valid only for a limited time to enhance security. The system monitors the salt's validity and determines that it has become invalid once the expiration period has elapsed. Alternatively, the system may detect the invalidity of the cryptographic salt when attempting to retrieve it for PSK regeneration during an authentication request. For example, when the system processes an IKEv2 authentication request and retrieves the stored salt to regenerate the PSK, it may determine that the salt has expired or is otherwise invalid. In such cases, the system rejects the authentication attempt and proceeds to generate a new salt and PSK, ensuring that only up-to-date credentials are used for secure access. This approach helps prevent unauthorized access and ensures that the authentication process remains robust and resistant to potential security threats.

According to various embodiments, if the system determines that a PSK has been compromised, such as upon detecting suspicious or abnormal behavior from an endpoint, it takes immediate/pro-active measures to protect the security of the network. Suspicious behaviors may include repeated failed authentication attempts, unusual access patterns, or deviations from normal session activity that suggest a potential security threat. In response to such a determination, the system proactively invalidates the master key from which the compromised PSK was derived. By doing so, the system ensures that all PSKs previously generated using the invalidated master key are no longer valid, effectively preventing any unauthorized access attempts based on compromised credentials. Once the master key is invalidated, an administrator provides/configures a new master key, or another system or service generates a new master key and, consequently, new PSKs for endpoints that require access (e.g., in response to re-login/authentications of the endpoints with the system/gateway), ensuring continued secure communication within the network.

In implementations where an endpoint attempts to use a PSK that was generated with an invalidated master key, the system will detect the inconsistency during the authentication process. When an endpoint submits an IKEv2 authentication request using a previously issued PSK, the system retrieves the newly generated master key and uses it to regenerate the expected PSK for decrypting the authentication payload. Because the endpoint is still using an old PSK derived from the invalidated master key, the decryption process will fail, resulting in an authentication failure. This mechanism ensures that endpoints relying on compromised credentials are denied access, prompting them to reauthenticate and obtain updated credentials. By implementing this proactive security measure, the system enhances its resilience against credential-based attacks while maintaining a secure and trusted authentication framework.

In some embodiments, the system is implemented through one or more servers acting as security gateways for enterprise networks. These servers can safeguard access to enterprise resources by strictly authenticating endpoints based on the techniques described herein.

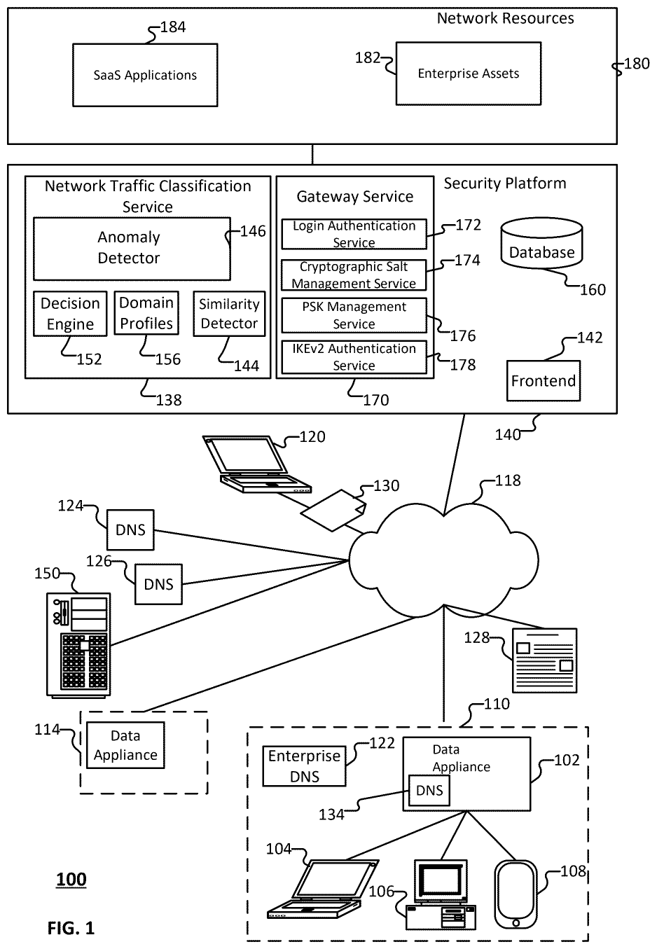

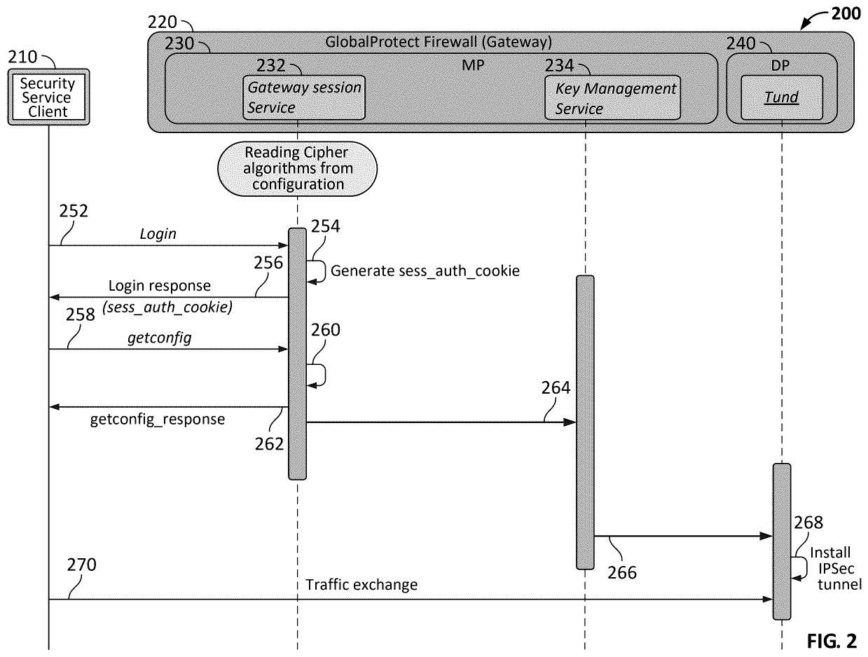

FIG. 1 is a block diagram of an environment for providing a security service to a network according to various embodiments. In some embodiments, system 100 implements at one or more of processes 200-1100 of FIGS. 2-11.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively blocking or sinkholing traffic, such as traffic to malicious domains, DNS hijacked domains, stockpiled domains, or squatting domains, or such as traffic for certain applications (e.g., SaaS applications). In some embodiments, data appliance 102 is also configured to enforce policies with respect to traffic that stays within (or from coming into) enterprise network 110.

System 100 comprises a security platform 140 that can provide security services for network resources 180, such as enterprise assets and/or software-as-a-service (SaaS) applications 184. For example, security platform 140 can perform authentication services for authentication of endpoints, such as client devices 104-108, in connection with providing access to network resources 180.

Techniques described herein can be used in conjunction with a variety of platforms (e.g., desktops, mobile devices, gaming platforms, embedded systems, etc.) and/or a variety of types of applications (e.g., Android . ask files, iOS applications, Windows PE files, Adobe Acrobat PDF files, Microsoft Windows PE installers, etc.). In the example environment shown in FIG. 1, client devices 104-108 are endpoints, such as a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including authenticating endpoints, providing secure access to network resources 180, resolving DNS queries, providing DNS resolving security services, classifying domains (e.g., predicting whether a domain is a malicious domain, etc.), classifying DNS response records (e.g., predicting whether a domain IP pair in a DNS response is a DNS hijacked record, etc.), classifying network traffic, classifying DNS traffic, providing a mapping of signatures to certain domains or DNS records (e.g., a DNS record for which a predicted likelihood that the record is a DNS hijacked record exceeds a predefined likelihood threshold, etc. a mapping of domains or DNS records to domain or DNS record data (e.g., domain certificates, pDNS data, active DNS data, WHOIS data, etc.), performing static and dynamic analysis on malware samples, monitoring new domains and new DNS records (e.g., detecting new domains for which a certificate is issued/generated), assessing maliciousness of domains, determining whether a DNS record associated with a traffic sample is (or is likely to be) a DNS hijacked record, detecting squatting domains, detecting a DNS cache poisoning attack (e.g., an attempt or a DNS cache entry stored based on an effective DNS cache poisoning attack), providing a list of signatures of known exploits (e.g., malicious input strings, malicious files, malicious domains, etc.) to data appliances, such as data appliance 102 as part of a subscription, detecting exploits such as malicious input strings, malicious files, DNS hijacked records or malicious domains (e.g., an on-demand detection, or periodical-based updates to a mapping of domains or DNS records to indications of whether the domains or DNS records are malicious or benign), providing a likelihood that DNS traffic (e.g., a domain or DNS record comprised in the DNS traffic) is malicious or benign, providing/updating a whitelist of input strings, files, or domains deemed to be benign, providing/updating input strings, files, or domains deemed to be malicious, identifying malicious input strings, detecting malicious input strings, detecting malicious files, predicting whether input strings, files, DNS records, or domains are malicious, providing an indication that an input string, file, DNS record, or domain is malicious (or benign), etc.

In some embodiments, network security services, such as authentication services, are implemented at data appliance 102. As an example, data appliance 102 can authenticate endpoints for access to network resources 180. The authentication services may include performing IKEv2 authentication for the endpoints.

In some embodiments, network security services are implemented by one or more servers, such as a cloud service. Examples of the network security services include one or more of: (a) authenticating a login request from an endpoint, (b) obtaining (e.g., generating) session authentication cookies (e.g., in response to login authentications), (c) assigning session authentication cookies to endpoints (e.g., to endpoints for particular sessions between the endpoints and the enterprise network, (d) providing the session authentication cookies to endpoints (e.g., via a secure communication protocol), (e) obtaining (e.g., generating PSKs), (f) providing PSKs to endpoints, (g) performing IKEv2 authentication for endpoints, (h) decrypting IKEv2 authentication requests or payloads in the IKEv2 authentication requests (e.g., using a PSK assigned to the endpoint, (i) extracting a session authentication cookie from the IKEv2 authentication request (e.g., from a decrypted payload comprised in the IKEv2 authentication request), (j) validating the PSK used to encrypt the IKEv2 authentication (e.g., based on a successful encryption of the IKEv2 authentication), (i) validating the session authentication cookie comprised in the IKEv2 authentication request (e.g., based on comparing the session authentication cookie obtained from the IKEv2 authentication request with a server-side version of the session authentication request associated with the endpoint or session of the endpoint), (k) providing access to network resources 180, etc.

In various embodiments, results of analysis (and additional information pertaining to applications, domains, etc.), such as an analysis or classification performed by security platform 140, are stored in database 160. In various embodiments, security platform 140 comprises one or more dedicated commercially available hardware servers (e.g., having multi-core processor(s), 32G+of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+Gigabytes of RAM, and one or more Gigabit network interface adapters) that runs commercially available virtualization software, such as VMware Six, Citrix eServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

According to various embodiments, security platform 140 comprises/implements network traffic classification service 138 and/or gateway service 170. Security platform 140 may include various other services/modules, such as a malicious file detector, a malicious traffic detector, a parked domain detector, an application classifier or other traffic classifier, etc.

Network traffic classification service 138 is used in connection with analyzing network traffic (e.g., websites, domains, sample files, etc. pertaining to the network traffic) and/or automatically detecting malicious network traffic.

Gateway service 170 is used in connection with providing security services for a network and network resources 180. Gateway service 170 can be implemented to perform IKEv2 authentication for endpoints, such as in connection with exposing network resources 180 to endpoints connected to the network. In some embodiments, gateway service 170 performs an IKEv2 authentication to authenticate endpoints based at least in part on a session authentication cookie (e.g., assigned for a particular session between the endpoint and the system) and the PSK. Gateway service 170 can manage the session authentication cookies and PSKs for authenticating endpoints, and provide the session authentication cookies and PSKs to the applicable endpoints via a secure connection. In response to receiving an IKEv2 authentication request, gateway service 170 can use server-side versions of a session authentication cookie and a PSK to validate the versions of the session authentication cookie and PSK that were used in connection with generating the IKEv2 authentication request. In response to validating the versions of the session authentication cookie and PSK used in connection with generating the IKEv2 authentication request, gateway service 170 authenticates the endpoint and, for example, provides the endpoint with access to network resources 180 (e.g., enterprise assets 182 and SaaS applications 184).

In connection with attempting to access certain secure resources, such as network resources 180, the endpoint performs an IKEv2 authentication with the system. The endpoint obtains the session authentication cookie (e.g., the locally stored session authentication cookie) and inserts it into a payload in an IKEv2 authentication request. The endpoint subsequently uses the PSK (e.g., the locally stored version of the PSK) to encrypt at least part of the IKEv2 authentication request, for example, the payload of the IKEv2 authentication request. The endpoint then sends the IKEv2 authentication request to the system (e.g., to security platform 140, or specifically, the gateway service 170).

In response to receiving the IKEv2 authentication request, the system (e.g., gateway service 170) determines the PSK associated with the endpoint, obtains the PSK (e.g., the server-side version of the PSK, for example, a PSK generated/re-generated at the server-side based on PSK information stored at the server-side), and uses the PSK to decrypt the IKEv2 authentication request (e.g., the session authentication cookie). In response to obtaining the decrypted payload of the IKEv2 authentication request, the system extracts a session authentication cookie and validates the extracted session authentication cookie (e.g., which had been locally stored at the endpoint) with the server-side version of the session authentication cookie. For example, the system determines whether the extracted session authentication cookie matches the server-side version of the session authentication cookie (e.g., is for the particular session between the endpoint and the system), and determines whether the extracted session authentication cookie is valid (e.g., unexpired).

In some embodiments, gateway service 170 comprises one or more of login authentication service 172, cryptographic salt management service 174, PSK management service 176, and/or IKEv2 authentication service 178.

Gateway service 170 provides security services for network resources, for example, by providing IKEv2 authentication of endpoints. In connection with providing such services, gateway service 170 can perform login authentication for endpoints, manage session authentication cookies for sessions between the system (e.g., gateway service 170) and endpoints, manage PSKs for endpoints, and use the appropriate session authentication cookie and PSK to authenticate a received IKEv2 authentication request.

Gateway service 170 uses login authentication service 172 to authenticate a login request. Before seeking IKEv2 authentication an endpoint may log into the system using a set of credentials, for example, a username (or other identifier) and passcode (e.g., password, pin, alphanumeric string, etc.). Login authentication service 172 can receive a login request from an endpoint and in response to receiving the login request, perform a login authentication (e.g., determine whether the passcode associated with the username is valid).

Gateway service 170 uses cryptographic salt management service 174 to manage cryptographic salts generated for endpoints (e.g., for generating PSKs for the endpoints). In some embodiments, cryptographic salt management service 174 generates a cryptographic salt in connection with gateway service 170 determining a PSK to be provided to an endpoint for performing IKEv2 authentications with the system (e.g., with gateway service 170). A new cryptographic salt can be obtained (e.g., generated) for each login session between the endpoint and the system (e.g., gateway service 170).

Cryptographic salt management service 174 can generate the cryptographic salt for an endpoint based at least in part on an identifier for an endpoint. The identifier for the endpoint may uniquely identify the endpoint, at least among a set of endpoints connected to the network via gateway service 170. In some embodiments, the identifier for the endpoint used in determining the cryptographic salt is based on a timestamp associated with a connection between an endpoint and the gateway (e.g., a timestamp of when the endpoint authenticated using user credentials, a timestamp associated with the receipt of a getconfig request from the endpoint, a timestamp of when the session between the endpoint and the gateway began, etc.). In other implementations, various other unique identifiers associated with the endpoint can be used in connection with determining the cryptographic salt.

Cryptographic salt management service 174 can store the cryptographic salt in association with the endpoint, such as in association with a unique identifier associated with the endpoint. In some embodiments, cryptographic salt management service 174 stores the cryptographic salt generated for an endpoint in association with a virtual IP address for the endpoint (e.g., the virtual IP address of the endpoint for the session between the endpoint and gateway service 170). In other implementations, various other unique identifiers associated with the endpoint can be used in connection with storing the cryptographic salt.

Gateway service 170 uses cryptographic salt management service 174 to obtain (e.g., retrieve) the cryptographic salt for an endpoint in connection with authenticating the endpoint, such as for validating a PSK used by the endpoint to encrypt at least part of an authentication request (e.g., an authentication payload for an IKEv2 authentication request). For example, in response to determining that the endpoint is to be authenticated, gateway service 170 can perform a lookup (e.g., based on the virtual IP address for the endpoint, or other such unique endpoint identifier in association with which the cryptographic salt is stored) to obtain the cryptographic salt for the endpoint. The system (e.g., gateway service 170) can use the retrieved cryptographic salt to generate a server-side or gateway-side PSK (e.g., regenerate the PSK for the endpoint for use in validating the PSK locally stored at the endpoint). The system uses the regenerated PSK (e.g., the server-side or gateway-side PSK) to decrypt at least part of the authentication request, such as an authentication payload comprised in the authentication request.

The system (e.g., security platform 140 such as via gateway service 170) securely stores the cryptographic salt in association with the endpoint to facilitate efficient and secure authentication processes. Specifically, the system maps the cryptographic salt to a virtual IP address assigned to the endpoint during its session with the gateway. This association allows the system to quickly retrieve the correct salt whenever it is needed to validate the endpoint's authentication requests. For instance, the system maintains a locally stored mapping that links virtual IP addresses to their corresponding cryptographic salts. This mapping is securely stored within the gateway to ensure the confidentiality and integrity of the authentication process, preventing unauthorized access to sensitive cryptographic information.

When the system (e.g., gateway service 170) receives an IKEv2 authentication request from an endpoint, the system uses cryptographic salt management service 174 to retrieve the previously stored cryptographic salt to facilitate authentication. The system determines the virtual IP address associated with the endpoint based on information contained in the request and performs a lookup in its stored mapping to obtain the corresponding cryptographic salt. Using the retrieved salt and the master key securely stored within the gateway, the system regenerates the PSK by applying the predefined key derivation function (KDF). This regenerated PSK is then used to decrypt the authentication payload included in the IKEv2 authentication request. If the decryption process is successful and the extracted data matches the expected values, the system authenticates the endpoint. This process ensures that the authentication mechanism remains both secure and efficient, leveraging stored cryptographic salts to enable rapid and reliable validation of authentication requests.

Gateway service 170 uses PSK management service 176 to manage PSKs. PSK management service 176 can obtain (e.g., generate) a PSK in response to a getconfig request received from the endpoint. In some embodiments, the PSK management service 176 generates a PSK for a particular endpoint. For example, the PSK can be generated for a particular session between the endpoint and the system. In some embodiments, the PSK management service 176 can store the PSK (e.g., at the server-side/gateway-side) in association with the endpoint and/or the particular session. In some embodiments, the PSK management service 176 can store PSK information (e.g., at the server-side/gateway-side) in association with the endpoint and/or the particular session. At the server side, the PSK information (e.g., a master key, a cryptographic salt, etc.) can be used to generate (e.g., re-generate) the PSK. The PSK management service 176 sends the PSK to the endpoint (e.g., for local storage), such as by a secure connection in a getconfig response.

In some embodiments, the endpoint is required to be logged into the system (e.g., the login authentication with the gateway is successful) before performing an IKEv2 authentication with the system (e.g., the gateway, such as gateway service 170). When the endpoint attempts to perform an IKEv2 authentication, the endpoint uses the session authentication cookie and PSK, such as in connection with obtaining (e.g., generating) the IKEv2 authentication request. For example, the endpoint uses (e.g., inserts) the session authentication cookie as a payload for the IKEv2 authentication request and uses the PSK for encryption associated with the IKEv2 authentication request. The endpoint can encrypt the payload for the IKEv2 authentication request based at least in part on the PSK.

In some embodiments, gateway service 170 (e.g., PSK management service 176) generates the PSK by utilizing a secure cryptographic process that combines a master key with a cryptographic salt. To derive the PSK, the system applies a key derivation function (KDF), which takes the master key and the cryptographic salt as inputs to produce a strong, session-specific key. This process ensures that the PSK is both unique and resistant to brute force attacks, enhancing the security of the authentication process. The system (e.g., gateway service 1790 triggers the generation of the cryptographic salt when it determines that the endpoint has successfully authenticated (e.g., via login authentication service 172) using valid credentials, such as a username and password. This approach ensures that each authentication session is protected by a distinct PSK, reducing the risk of unauthorized access due to key reuse.

According to various embodiments, the cryptographic salt is generated based on a unique identifier associated with the endpoint, which helps to ensure uniqueness and prevents collisions across different sessions. In some implementations, the cryptographic salt is derived from a timestamp associated with the endpoint, such as the session start time, the moment when the PSK is being generated, or the time at which the endpoint submits a configuration request (e.g., a getconfig request) to the system. This timestamp-based approach further enhances the security of the generated PSK by incorporating temporal elements that make each session's key derivation unique. The master key used in the PSK generation process is predefined and securely stored locally at the gateway (e.g., at security platform 140, such as in database 160), ensuring that it remains protected from unauthorized access. In certain embodiments, each gateway in the network is assigned a unique master key, which further compartmentalizes security across the network and prevents potential compromises from affecting multiple gateways.

Gateway service 170 uses IKEv2 authentication service 178 to perform authentication of IKEv2 authentication requests received at the system/gateway such as from endpoints connected to the network. In some embodiments, IKEv2 authentication service 178 performs the authentication based at least in part on a session authentication cookie and a PSK. For example, IKEv2 authentication service 178 uses the session authentication cookie stored at the server-side (e.g., the gateway-side) for the particular session to validate a session authentication cookie comprised in IKEv2 authentication service 178. IKEv2 authentication service 178 performs a lookup with respect to a mapping of endpoints (or sessions with endpoints) to session authentication cookie to obtain the appropriate session authentication cookie to use for the authentication.

In some embodiments, in response to receiving the IKEv2 authentication request, IKEv2 authentication service 178 determines the endpoint and/or session with which IKEv2 authentication request is associated. IKEv2 authentication service 178 can obtain the appropriate PSK (e.g., the server-side/gateway-side stored PSK, re-generate the PSK based on PSK information such as a master key, cryptographic sale, etc.) to use in connection with the authentication. For example, the IKEv2 authentication service 178 performs a lookup with respect to a mapping of endpoints (or sessions with endpoints) to PSKs to obtain the appropriate PSK to use for the authentication. IKEv2 authentication service 178 uses the PSK for decrypting information comprised in IKEv2 authentication request, such as the payload comprised in IKEv2 authentication request. In response to successful decryption using the PSK, IKEv2 authentication service 178 can deem the PSK used by the endpoint (e.g., to encrypt the payload) as being validated. IKEv2 authentication service 178 obtains the decrypted payload and extracts a session authentication cookie embedded in (e.g., comprised in) the IKEv2 authentication request. The obtained session authentication cookie corresponds to a version of the session authentication cookie stored at the endpoint-side and used to generate the IKEv2 authentication request. IKEv2 authentication service 178 obtains a server-side version of the session authentication cookie associated with the endpoint and/or the particular session with the endpoint and validates the version of the session authentication cookie extracted from the IKEv2 authentication request (e.g., the decrypted payload of the IKEv2 authentication request) based at least in part on the server-side version of the session authentication cookie. For example, IKEv2 authentication service 178 compares the server-side version of the session authentication cookie with the session authentication cookie extracted from the IKEv2 authentication request. In response to determining that the server-side version of the session authentication cookie matches the session authentication cookie extracted from the IKEv2 authentication request, IKEv2 authentication service 178 deems the session authentication cookie extracted from the IKEv2 authentication request to be valid.

In some embodiments, IKEv2 authentication service 178 determines that the IKEv2 authentication is successful in response to validation using the appropriate PSK and validation using the appropriate session authentication cookie. For example, IKEv2 authentication service 178 in response to determining that (i) the PSK used by the endpoint to encrypt at least the payload comprised in the IKEv2 authentication request is valid, and (ii) the session authentication cookie extracted from the (decrypted) payload of the IKEv2 authentication request is valid. In response to determining that the IKEv2 authentication is successful, the system (e.g., gateway service 170) can provide the endpoint with access to network resources 180.

Network traffic classification service 138 may comprise an anomaly detector 146 (e.g., configured to detect anomalies in network traffic, file samples obtained by intercepting traffic, DNS traffic, or DNS records, etc.), a decision engine 152 (e.g., configured to predict whether network traffic, intercepted file samples, or whether a DNS record is malicious), domain profiles 156, and/or a similarity detector 144. In some embodiments, network traffic classification service 138 detects malicious network traffic or malware obtained from intercepted network traffic (e.g., by classifying a file sample obtained by a security entity or other network node requesting a maliciousness classification).

Network traffic classification service 138 can determine the classification for network traffic (e.g., a file sample obtained from network traffic, a DNS record, a DNS query, a DNS response, a website content, etc.) based at least in part on querying a classifier(s). The classifier that is queried to provide a classification of the network traffic sample associated with the network activity is a fingerprinting-based classifier, a heuristics-based classifier, another rule-based classifier, and/or a machine-learning based classifier. The classifier may be trained based at least in part on historical samples (e.g., samples of network traffic samples extracted from network traffic). The classifier can be trained based at least in part on a machine learning process.

The classifier(s) may implement one or more machine learning models that may be trained according to a machine learning process. Examples of machine learning processes that can be implemented include random forest, linear regression, support vector machine, naive Bayes, logistic regression, K-nearest neighbors (KNN), decision trees, gradient boosted decision trees, K-means clustering, hierarchical clustering, density-based spatial clustering of applications with noise (DBSCAN) clustering, principal component analysis, a neural network (NN), XGBoost, a convolutional neural network (CNN), and LLM etc.

According to various embodiments, security platform 140 may receive a query from a security entity (e.g., inline firewall, such as a next generation firewall) for a real-time or offline classification of a network traffic sample, such as a file.

According to various embodiments, in response to network traffic classification service 138 classifying the network traffic sample, system 100 handles the corresponding network traffic according to a predefined policy (e.g., a security policy). For example, in response to predicting that the network traffic sample corresponds to malicious network traffic (e.g., that the domain associated with the network traffic is a squatting domain), system 100 can cause the network traffic to be blocked or quarantined, etc. As another example, system 100 can cause traffic to/from a compromised host (e.g., the client system associated with the intercepted network traffic from which the malicious domain was extracted) to be quarantined or sinkholed, etc. (e.g., at least until an administrator actively configures system 100 to proceed with permitting traffic to/from the client system, such as in response to the compromised host being remediated).

According to various embodiments, in response to network traffic classification service 138 classifying the network traffic (e.g., the network traffic sample, or a domain associated with the network traffic sample), system 100 handles the network traffic according to a predefined policy (e.g., a security policy). For example, the system queries a traffic handling policy to determine the manner by which the network traffic (e.g., network activity for a session associated with the network traffic sample) is to be handled. The traffic handling policy may be a predefined policy, such as a security policy, etc. The traffic handling policy may indicate that network traffic associated with certain domains (e.g., domains classified as squatting domains) or having certain characteristics/profiles is to be blocked and network traffic associated with other domains (e.g., domains not deemed to be squatting domains or otherwise malicious) or having other characteristics/profiles is to be permitted to pass through the system (e.g., routed normally). The traffic handling policy may correspond to a repository of a set of policies to be enforced with respect to network traffic. In some embodiments, security platform 140 receives one or more policies, such as from an administrator or third-party service, and provides the one or more policies to various network nodes, such as endpoints, security entities (e.g., inline firewalls), etc.

In response to determining a classification for a newly analyzed network traffic sample (e.g., a newly analyzed domain for a particular network traffic sample, such as a DNS request or DNS response), security platform 140 (e.g., network traffic classification service 138) sends an indication that network activity (e.g., other network traffic samples) associated with the domain are associated with, or otherwise correspond to, the determined classification. Security platform 140 can provide an indication that network traffic matching the network traffic sample predicted to be malicious (e.g., network traffic matching a domain predicted to be a squatting domain) is to be handled as a malicious network traffic. For example, security platform 140 determines (e.g., computes) a signature or identifier for the network traffic/activity (e.g., a hash or other signature, or identifier for the corresponding network session or domain), and sends to a network node (e.g., a security entity, an endpoint such as a client device, etc.) an indication of the classification associated with the signature (e.g., an indication whether the network traffic/activity is a malicious or non-malicious). Security platform 140 may update a mapping of signatures to network traffic sample classifications and provide the updated mapping to the security entity. In some embodiments, security platform 140 further provides to the network node (e.g., security entity, client device, etc.) an indication of a manner by which network traffic/activity matching the network traffic sample or otherwise be associated with the same session as the network traffic sample classified as malicious or matching the signature is to be handled. For example, security platform 140 provides to the security entity a traffic handling policy, a security policy, or an update to a policy.

According to various embodiments, in response to determining the maliciousness classification for a network traffic sample (e.g., obtaining the predicted maliciousness classification, such as from a classifier), network traffic classification service 138 provides an indication of the maliciousness classification, such as to the applicable security entity (e.g., the security entity that provided the network traffic sample or a security entity mediating network traffic for the session associated with the network traffic sample).

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within enterprise network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable. In some embodiments, gateway service 170 is implemented at enterprise DNS server 122 rather than, or in addition to, being implemented at security platform 140.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite. com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious domains, detecting parked domains, or otherwise determining that certain detected network traffic is to be further analyzed (e.g., using a finer detection model).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

FIG. 2 is a block diagram of a system for providing access to network resources according to various embodiments. In the example shown, system 200 comprises a security service client 210 and a firewall 220. Security service client 210 may be installed/running on an endpoint, such as a client system.

In some embodiments, firewall 220 comprises gateway service 230. Gateway service 230 may be a management plane Gateway service 230 may comprise gateway session service 232, which may be a process or service that provide backend logic for an SSL VPN or security service. As an example, gateway session service 232 is primarily concerned with configuration data. This includes specifying which RAS objects can be created, their options, and how they are connected. When an application requests an object, such as a message logger, gateway session service 232 creates it from its configuration data and returns it. Additionally, gateway service 230 may comprise key management service 234, which may be a process or service that performs key repository management. Gateway session service 232 and key management service 234 may be used to provide security for a data plane 240.

At 252, the endpoint (e.g., via security service client 210) sends a login request to firewall 220. Firewall 220 (e.g., gateway service 230) uses gateway session service 232 to perform an authentication of the endpoint, such as based on login credentials comprised in the login request. At 254, gateway session service 232 generates a session authentication cookie upon successful login authentication of the endpoint. Firewall 220 (e.g., gateway service 230, or specifically gateway session service 232) sends the session authentication cookie back to the endpoint (e.g., the security service client 210). At 258, the endpoint sends to firewall 220 (e.g., to gateway service 230) a getconfig request. In response to receiving the getconfig request, at 260, gateway service 230 (e.g., gateway session service 232) configures a tunnel, such as including generating a tunnel identifier, and populating the appropriate keys. At 262, gateway service 230 (e.g., gateway session service 232) sends a getconfig response to the endpoint. For example, gateway session service 232 sends tunnel configuration information, including the populated keys. Additionally, at 264, gateway session service 232 sends (e.g., pushes) this configuration information to key management service 234. In response to receiving the tunnel configuration information, at 266, key management service 234 sends the tunnel configuration information to data plane 240. At 268, firewall 220 (e.g., key management service 234 or data plane 240) installs or configures the tunnel with data plane 240. At 270, firewall 220 provides the endpoint with access to data plane 240 via the configured tunnel.

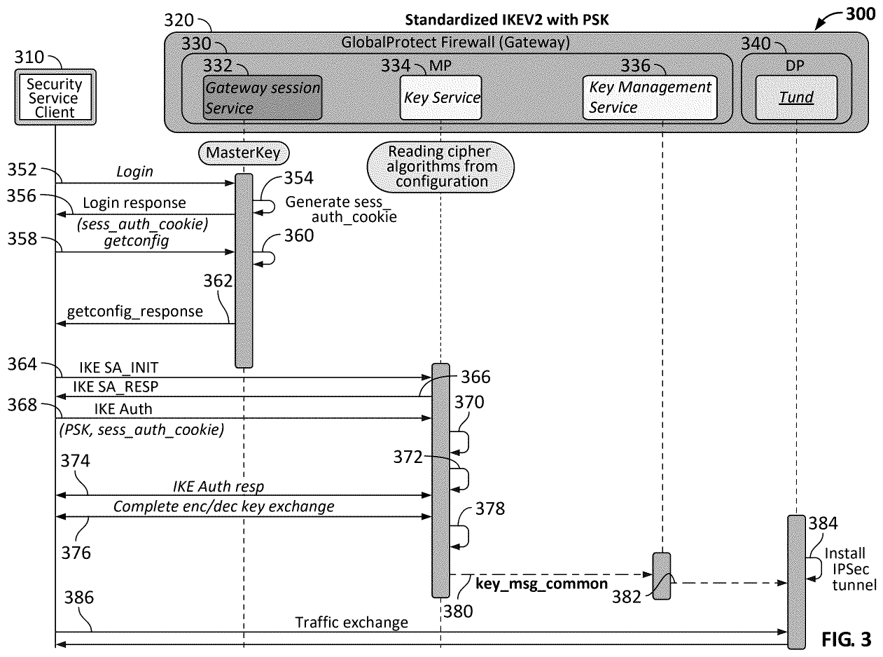

According to various embodiments, in connection with performing IKEv2 authentication, an endpoint (e.g., a security service client 210 running on the endpoint) initiates a IKEv2 key exchange via an IKEv2 SA_INIT initiation message and IKEv2 authentication message. One of the options is to use a pre-shared key in the authentication payload during IKEv2 authentication. As part of the IKEV2 authentication message, the endpoint (e.g., a security service client 210 running on the endpoint) sends a PSK as the identity field to authenticate the end-user or the endpoint (e.g., a security service client 210 running on the endpoint). This PSK is a pre-shared and pre-agreed upon phrase between the initiator and the responder. The system (e.g., a gateway service, such as gateway service 230 of FIG. 2 or gateway service 330 of FIG. 3) will authenticate the endpoint (e.g., a security service client 210 running on the endpoint) during a gateway IKEv2 authentication session. For example, the system authenticates the endpoint based on the authentication payload information comprised in the IKEv2 authentication message. In related art systems, however, the IKEv2 authentication message will not have any information related to the end user to authenticate at the firewall (e.g., the gateway service). Accordingly, related art firewalls or gateway services prompt the user to enter the username/password to validate and authenticate the user's IKE session. This will pose a manual intervention problem at the client end (e.g., at the endpoint). In addition, the user/endpoint is now caused to enter username/password twice (e.g., once during login and another during IKE authentication, which is duplicate effort).

Usually, user-chosen passwords are unlikely to have sufficient unpredictability to resist dictionary attacks. In addition, in some instances these attacks are not prevented in a PSK-based IKEV2 authentication method. Accordingly, any intruder who can guess the password (e.g., the login credentials) of the user or knows the PSK can initiate an IKEv2 authentication session with the firewall (e.g., the gateway service) and become IKEv2 authentication with respect to the gateway service. This poses a security threat to IKEv2 for the gateway service. Accordingly, a more secure way to validate that the end user is required. Various embodiments address these security concerns and facilitate automatic and secure IKEv2 authentication with the gateway service.

In some embodiments, the system uses a session authentication cookie in connection with an IKEv2 authentication. The system may authenticate an endpoint based at least in part on the session authentication cookie used during IKEv2 authentication. The session authentication cookie is generated when the user logs into a gateway service (e.g., a gateway provided by a firewall) by submitting login credentials. As an example, the login credentials include a user identifier (e.g., a username) and passcode (e.g., a password, a pin, etc.). The gateway service provides the endpoint with the session authentication cookie (e.g., in response to login authentication) and a PSK over a hypertext transfer protocol secure (HTTPS) secure channel. The endpoint (e.g., the security service client running on the endpoint) uses this PSK in connection with determining the IKEv2 authentication request message. For example, the endpoint inserts the PSK into the identity field (e.g., the authentication payload) of the IKEv2 authentication request message. As another example, the endpoint uses the PSK to encrypt the information comprised in the identity field (e.g., the authentication payload) of the IKEv2 authentication request message. According to various embodiments, the endpoint (e.g., the security service client) inserts the session authentication cookie (e.g., for the particular session between the endpoint and the gateway) into the identity field (e.g., the authentication payload) of the IKEv2 authentication request message. As an example, the endpoint inserts the session authentication cookie into the authentication payload and uses the PSK to encrypt the authentication payload. At the firewall (e.g., the gateway service), the firewall decodes (e.g., decrypts) the authentication payload the PSK information. For example, the gateway service obtains a PSK for the endpoint based at least in part on PSK information that is stored on the gateway-side, and uses the obtained PSK to decrypt the IKEv2 authentication request message (e.g., the authentication payload extracted from the IKEv2 authentication request message). The gateway service may obtain a PSK for the endpoint based at least in part on obtaining PSK information (e.g., a master key, a cryptographic salt associated with the endpoint/session, etc.), and regenerates the PSK based at least in part on the PSK information. In response to decoding (e.g., decrypting the authentication payload), the gateway service extracts a session authentication cookie from the authentication payload. The gateway service uses the extracted session authentication cookie to validate and authenticate the endpoint (e.g., the user) with the gateway service. For example, the gateway service compares the extracted session authentication cookie with a gateway-side stored version of the session authentication cookie assigned for the particular endpoint session, and determines that the extracted session authentication cookie is valid if the two versions of the session authentication cookie match.

Accordingly, in some embodiments, the gateway service can authenticate the IKEv2 session of the end user automatically without prompting for the user to enter input credentials (e.g., a username/password) again.

FIG. 3 is a block diagram of a system for providing access to network resources according to various embodiments. In the example shown, system 300 comprises a security service client 310 and a firewall 320. Security service client 310 may be installed/running on an endpoint, such as a client system. In some embodiments, firewall 320 comprises gateway service 330. Gateway service 330 may store a master key, for example, a unique key among master keys for the various gateways in the network. Gateway service 330 can use the master key in connection with generating the PSK for the endpoint.

In some embodiments, firewall 320 comprises gateway service 330. Gateway service 330 may comprise gateway session service 332, which may be a process or service that provide backend logic for an SSL VPN or security service. Gateway session service 332 may be responsible for handling user-related configuration on the gateway, allocate IP addresses to endpoints (e.g., to clients), generating session authentication cookies, and/or validating an end user in conjunction with another authentication process. As an example, Gateway session service 332 is primarily concerned with configuration data. This includes specifying which RAS objects can be created, their options, and how they are connected. When an application requests an object, such as a message logger, gateway session service 332 creates it from its configuration data and returns it. Gateway service 30 may additionally comprise key service 334, which is configured to perform IKEv2 authentication for endpoints. Additionally, gateway service 330 may comprise key management service 336, which may be a process or service that performs key repository management. Gateway session service 332, key service 334, and key management service 336 may be used to provide security for a data plane 340.

At 352, the endpoint (e.g., via security service client 310) sends a login request to firewall 320. Firewall 320 (e.g., gateway service 230) uses gateway session service 332 to perform an authentication of the endpoint, such as based on login credentials comprised in the login request. At 354, gateway session service 332 generates a session authentication cookie upon successful login authentication of the endpoint. The session authentication cookie can be randomly generated and may be a unique value for the particular session (e.g., the cookie may be unique across other session authentication cookies for sessions at the gateway). Firewall 320 (e.g., gateway service 330, or specifically gateway session service 332) sends the session authentication cookie back to the endpoint (e.g., the security service client 310). At 358, the endpoint sends to firewall 320 (e.g., to gateway service 330) a getconfig request. In response to receiving the getconfig request, at 360, gateway service 230 (e.g., gateway session service 332) obtains the PSK for the endpoint. In some embodiments, gateway service 330 generates the PSK, such as based on the master key (e.g., the master key assigned to and locally stored at the gateway service 330) and a cryptographic salt. The cryptographic salt may be a random value, such as a random value added to a password or data (e.g., the master key) before the value is hashed. A unique salt may be generated for each PSK to be generated. In some embodiments, the salt and the master key are combined and then hashed using a secure algorithm (e.g., a predefined algorithm/hashing function). Gateway service 330 can store the session authentication cookie and salt (or the PSK) locally. At 362, gateway service 330 (e.g., gateway session service 332) sends a getconfig response to the endpoint. Gateway service 330 can embed the PSK in the getconfig response.

At 364, the endpoint sends an IKEv2 initiation message. In response to receiving the IKEv2 initiation message, gateway service 330 can provide the message to key service 334. Gateway service 330 (e.g., key service 334) can provide an IKE response message to the endpoint. At 368, the endpoint configures an IKEv2 authentication request message and provides the IKEv2 authentication request message to gateway service 330 (e.g., key service 334). In some embodiments, the endpoint generates the IKEv2 authentication request message based at least in part on (a) obtaining the session authentication cookie for the session between the endpoint (e.g., security service client 310) and firewall 320 (e.g., gateway service 330), (b) embedding the session authentication cookie in the payload for the IKEv2 authentication request message, (c) obtaining the PSK (e.g., the PSK for the authentication between the endpoint and the gateway service), and (d) encrypting the payload for the IKEv2 authentication request message based at least in part on the PSK.

In response to receiving the IKEv2 authentication request, at 370, gateway service 330 can perform the IKEv2 authentication of the endpoint. In some embodiments, performing the IKEv2 authentication includes (i) obtaining the PSK associated with the endpoint, (ii) decrypting the IKEv2 authentication request (e.g., the payload for the IKEv2 authentication request), (iii) extracting a session authentication cookie (e.g., from the decrypted payload), and (iv) validating the extracted session authentication cookie. In some implementations, the obtaining the PSK includes performing a lookup (e.g., based on the endpoint or the particular session with the endpoint) of a locally stored (e.g., stored at the server-side or gateway-side) PSK. In other implementations, the system performs a lookup (e.g., based on the endpoint or the particular session with the endpoint) of the salt used to generate the PSK provided to the endpoint, and gateway service 330 locally re-generates the PSK, such as based on the salt and the master key for gateway service 330. For example, key service 334 makes an API call to gateway service 330 to decrypt the IKEv2 authentication request (or the payload comprised in IKEv2 authentication request) and to authenticate the endpoint.

In response to determining that the IKEv2 authentication request (or the payload comprised in IKEv2 authentication request) is successfully decrypted with the server-side/gateway-side version of the PSK (e.g., the locally stored PSK or the PSK generated using the salt stored in association with the session authentication cookie, etc.), gateway service 330 deems the PSK used by the endpoint (e.g., to encrypt the payload) as being validated. In response to successfully decrypting the IKEv2 authentication request (or the payload comprised in IKEv2 authentication request), the system validates the session authentication cookie extracted from the decrypted payload. For example, gateway service 330 performs a lookup for the locally stored (e.g., stored server-side or gateway-side) version of the session authentication cookie, such as based on an identifier of the endpoint and/or a session identifier for the session between the endpoint and gateway service 330. In response to obtaining the locally stored version of the session authentication cookie, gateway service 330 validates the session authentication cookie extracted from the decrypted payload based at least in part on the locally stored version of the session authentication cookie. For example, the system determines whether the session authentication cookie extracted from the decrypted payload matches the locally stored version of the session authentication cookie.

In some embodiments, the system determines that the IKEv2 authentication of the endpoint is successful if both the PSK and the session authentication cookie used to generate the IKEv2 authentication request are validated.

At 374, gateway service 330 (e.g., key service 334) provides an IKEv2 authentication response. As an example, the IKEv2 authentication response indicate whether the IKEv2 authentication was successful. Additionally, upon successful IKEv2 authentication, at 372, gateway service 330 (e.g., key service 334) generates/populates the appropriate keys, such as the keys to be used in connection with establishing a tunnel with data plane 340. At 376, the endpoint and gateway service 330 (e.g., key service 334) perform a key exchange. At 378, gateway service 330 (e.g., key service 334) generates a request for establishing a tunnel. For example, gateway service 330 (e.g., key service 334) makes an API call to obtain data (e.g., the appropriate keys) for establishing the tunnel. At 380, key service 334 provides the data (e.g., the appropriate keys) to key management service 336. For example, key service 334 sends (e.g., pushes) this configuration information to key management service 336. In response to receiving the tunnel configuration information, at 382, key management service 336 sends the tunnel configuration information to data plane 340. At 384, firewall 320 (e.g., key management service 336 or data plane 240340 installs or configures the tunnel with data plane 340. At 386, firewall 320 provides the endpoint with access to data plane 340 via the configured tunnel.

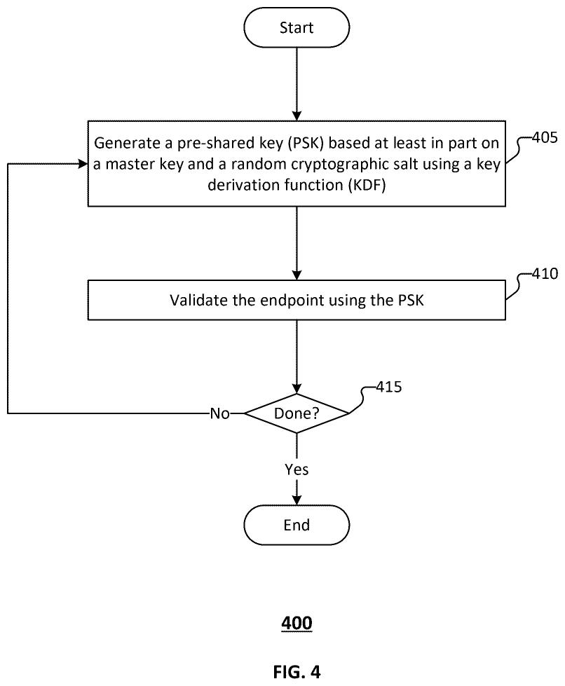

FIG. 4 is a flow diagram of a method for validating an endpoint according to various embodiments. According to various embodiments, process 400 is implemented at least in part by one or more of system 100 of FIG. 1 and/or system 300 of FIG. 3. In the example shown, the system receives an authentication request and performs an authentication (e.g., IKEv2 authentication) of the endpoint. In some embodiments, process 400 is implemented by a firewall or gateway, such as gateway service 170 of system 100 and/or gateway service 330 of FIG. 3.

In some embodiments, process 400 is implemented by a cloud service (e.g., one or more servers) that provides other network security services to various network endpoints or security entities. For example, the system may implement process 400 to authenticate endpoints such as in connection with exposing network assets to the endpoint.

According to various embodiments, the system generates a PSK by employing a secure and reliable cryptographic process based on a master key and a cryptographic salt. This process ensures that the PSK is both unique and session-specific, enhancing the security of the IKEv2 authentication mechanism. When the system determines that an endpoint has successfully authenticated using credentials such as a username and password, it initiates the generation of the PSK. This step can be implemented to ensure a secure communication channel between the endpoint and the system while ensuring that each session is protected with a distinct key.

To derive the PSK, the system utilizes a key derivation function (KDF) (e.g., a predefined KDF implemented at the gateway for computing PSKs), which takes as inputs the master key and a cryptographic salt. The KDF applies a series of cryptographic transformations to generate a strong, unpredictable key (e.g., the PSK) that the endpoint can use to encrypt authentication payloads. The use of a KDF provides enhanced security by ensuring that even if an attacker gains access to one PSK, it would be infeasible to derive other keys from it, as the function introduces computational complexity and randomness into the key generation process.

The cryptographic salt can be used to ensure the uniqueness of the PSK for each session or endpoint. The system generates the cryptographic salt dynamically when it is required to generate a PSK, such as upon successful authentication of the endpoint or in response to a getconfig request. The cryptographic salt is derived based on a unique identifier associated with the endpoint, ensuring that the PSK remains specific to the device or user. In certain embodiments, the cryptographic salt can be based on a timestamp, such as the timestamp marking the initiation of the session, the exact time when the PSK is determined to be generated, or the timestamp of the getconfig request sent by the endpoint. These timestamp-based cryptographic salts further enhance security by introducing temporal uniqueness to the key derivation process.

The master key used in the generation of the PSK is predefined and securely stored within the system, such as locally at the gateway. The master key serves as a foundational secret that, in some embodiments, is never exposed to the endpoint or external systems, maintaining the integrity of the key generation process. In some embodiments, each gateway within a network is assigned a unique master key, ensuring that the keys generated by different gateways remain independent of one another. This distributed approach enhances security across the network by isolating key spaces and preventing potential cross-gateway key compromise.

Through this secure PSK generation process, the system provides a robust mechanism for endpoint authentication, ensuring that session-specific keys are dynamically and securely generated. By incorporating unique cryptographic salts, timestamp-based values, and predefined master keys, the system mitigates risks associated with static keys, replay attacks, and unauthorized access attempts, making it a reliable solution for securing enterprise networks.

Returning to the example shown, at 405, the system generates a PSK based at least in part on a master key and a random cryptographic salt using a key derivation function (KDF). The system can generate and provide the PSK for an endpoint in response to the endpoint authenticating with the system (e.g., the gateway) using credentials (e.g., username and passcode). Additionally, the system can generate the PSK in response to receiving an authentication request (e.g., an IKEv2 authentication request) from the endpoint and in connection with validating the PSK used by the endpoint to encrypt at least part of the authentication request (e.g., the authentication payload comprised in the authentication request). At 410, the system validates the endpoint using the PSK and the session authentication cookie. At 415, the system determines whether process 400 is complete. In some embodiments, the system determines process 400 to be complete in response to a determination that authentication of the endpoint has completed, no further endpoints are to be authenticated, an administrator indicates that process 400 is to be paused or stopped, etc. In response to a determination that process 400 is complete, process 400 ends. In response to a determination that process 400 is not complete, process 400 returns to 405.

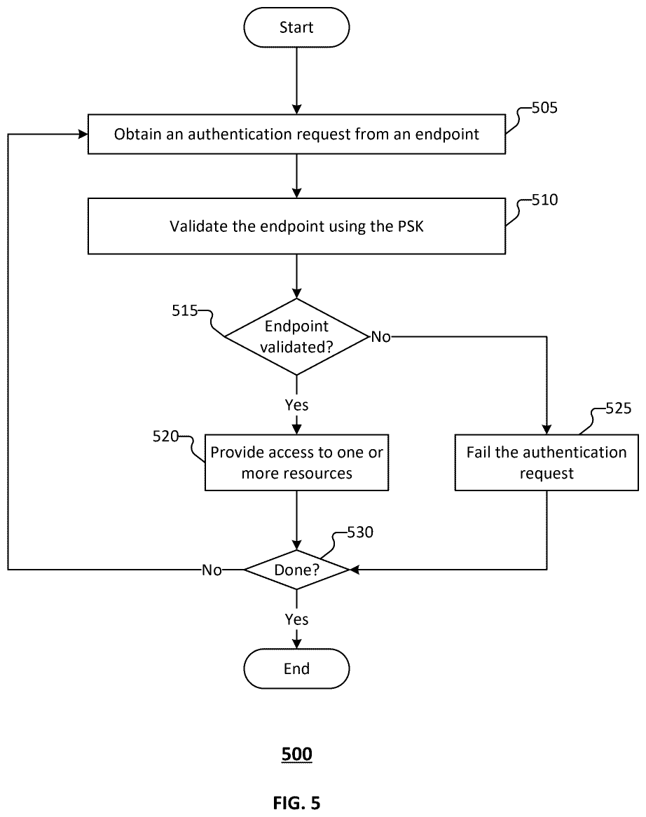

FIG. 5 is a flow diagram of a method for validating an endpoint according to various embodiments. According to various embodiments, process 500 is implemented at least in part by one or more of system 100 of FIG. 1 and/or system 300 of FIG. 3. In some embodiments, process 500 is implemented by a firewall or gateway, such as gateway service 170 of system 100 and/or gateway service 330 of FIG. 3.

In some embodiments, process 500 is implemented by a cloud service (e.g., one or more servers) that provides other network security services to various network endpoints or security entities. For example, the system may implement process 500 to authenticate endpoints such as in connection with exposing network assets to the endpoint.

At 505, the system obtains an authentication request from an endpoint. At 510, the system validates the endpoint using the PSK. For example, the system uses a server-side or gateway-side PSK to decrypt the authentication request. In response to successfully decrypting the authentication request (or a blob associated with the authentication request, such as an authentication payload), the system deems the endpoint to be validated, or at least that the PSK used by the endpoint to encrypt the authentication request (or a blob associated with the authentication request, such as an authentication payload) is validated. In some embodiments, the system obtains the server-side or gateway-side PSK based at least in part on an identifier associated with the endpoint. As an illustrative example, the system determines a virtual IP address of the endpoint in connection with the session between the endpoint and the system (e.g., the gateway) and performs a look up against a mapping of endpoint identifiers (e.g., virtual IP addresses) to cryptographic salts to obtain a cryptographic salt for the particular connection (e.g., session) between the endpoint and the system. The system can also obtain a locally stored master key and generate the PSK based on the master key and the cryptographic salt, for example, by invoking a predefined KDF. At 515, the system determines whether the endpoint is validated. In response to determining that the endpoint is validated, process 500 proceeds to 520 at which the system provides access to one or more resources. For example, the system provides the endpoint with access to the one or more resources exposed by the network (e.g., an enterprise network). In response to determining that the endpoint is not validated, process 500 proceeds to 525 at which the system fails the authentication request. In connection with failing the authentication request, the system can provide an indication to the endpoint that the authentication has failed. The system may additionally prompt the endpoint to retry authentication, or direct the endpoint to reinitiate a session with the system. At 530, the system determines whether process 500 is complete. In some embodiments, the system determines process 500 to be complete in response to a determination that authentication of the endpoint has completed, a session between an endpoint and gateway service is terminated, no further endpoints are to be authenticated, an administrator indicates that process 500 is to be paused or stopped, etc. In response to a determination that process 500 is complete, process 500 ends. In response to a determination that process 500 is not complete, process 500 returns to 505.

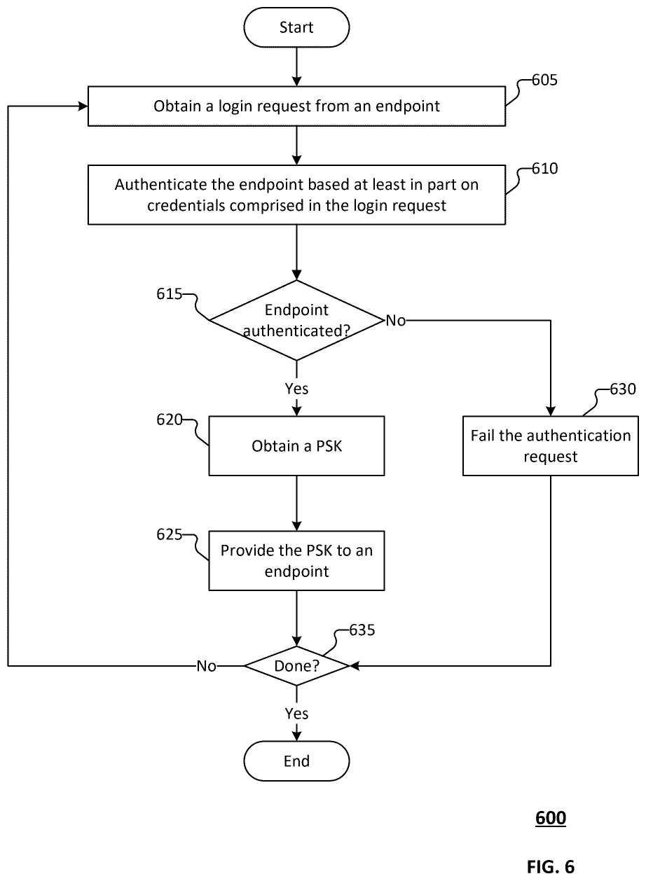

FIG. 6 is a flow diagram of a method for obtaining a session authentication cookie for an endpoint according to various embodiments. According to various embodiments, process 600 is implemented at least in part by one or more of system 100 of FIG. 1 and/or system 300 of FIG. 3. In some embodiments, process 600 is implemented by a firewall or gateway, such as gateway service 170 of system 100 and/or gateway service 330 of FIG. 3.

In some embodiments, process 600 is implemented by a cloud service (e.g., one or more servers) that provides other network security services to various network endpoints or security entities. For example, the system may implement process 600 to authenticate endpoints such as in connection with exposing network assets to the endpoint.

In some embodiments, the system generates the session authentication cookie as a unique identifier that facilitates secure and session-specific authentication for an endpoint. The session authentication cookie is created when an endpoint initiates a login process by sending a login request to the system. This request includes user credentials, such as a username and password, which the system validates to verify the identity of the user or device associated with the endpoint. Upon successful validation of the credentials, the system generates a session authentication cookie to associate with the specific session initiated by the endpoint.

The generation of the session authentication cookie may involve the use of a session authentication cookie service that produces a random and unique alphanumeric code or value. This randomness ensures that the cookie is difficult to predict or replicate, thereby reducing the risk of unauthorized access or replay attacks. The session authentication cookie is tied specifically to (e.g., associated with) the session for which it is created, and if the endpoint initiates a new session, the system generates and assigns a new session authentication cookie. This session-specific design adds an additional layer of security, ensuring that each session is uniquely identifiable and authenticated independently.

Once generated, the session authentication cookie is securely provided to the endpoint as part of the login response. The system transmits the session authentication cookie to the endpoint through a secure communication channel, such as an encrypted HTTPS connection. This secure transmission prevents interception or tampering by malicious actors during transit. By embedding the session authentication cookie within the login response, the system ensures that the endpoint receives the cookie in a manner that preserves its confidentiality and integrity.

The endpoint stores the session authentication cookie for use in subsequent authentication requests, such as during the IKEv2 authentication process. When the endpoint needs to authenticate with the system, it includes the session authentication cookie within the payload of the authentication request. This cookie, combined with other security measures like a PSK, enables the system to validate the session and authenticate the endpoint. The secure generation and provision of the session authentication cookie play a critical role in enhancing the overall security and reliability of the authentication process.

At 605, the system obtains a login request from an endpoint. At 610, the system authenticates the endpoint based at least in part on credentials comprised in the login request. At 615, the system determines whether the endpoint is authenticated. In response to determining that the endpoint is authenticated, process 600 proceeds to 620. At 620, the system obtains a PSK. At 625, the system provides the PSK to an endpoint. For example, the system provides the PSK in response to determining that the endpoint has successfully authenticated (e.g., using user credentials) with the system (e.g., the gateway). The system may provide the PSK in response to receiving a getconfig request from the endpoint, which the endpoint sends after successful authentication using the credentials. In response to determining that the endpoint is not authenticated, process 600 proceeds to 630 at which the system fails the authentication request. In connection with failing the authentication request, the system can provide an indication to the endpoint that the authentication has failed. The system may additionally prompt the endpoint to retry authentication, or direct the endpoint to reinitiate a session with the system. At 635, the system determines whether process 600 is complete. In some embodiments, the system determines process 600 to be complete in response to a determination that authentication of the endpoint has completed, a session between an endpoint and gateway service is terminated, no further endpoints are to be authenticated, an administrator indicates that process 600 is to be paused or stopped, etc. In response to a determination that process 600 is complete, process 600 ends. In response to a determination that process 600 is not complete, process 600 returns to 605.

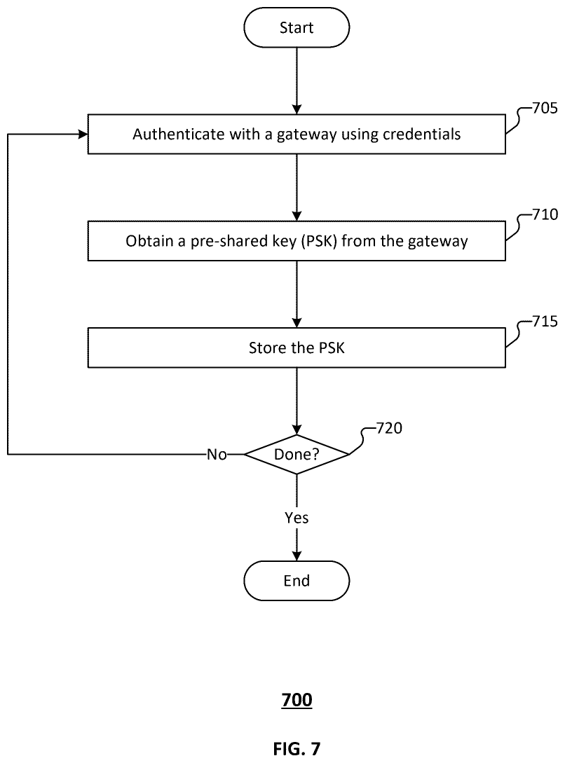

FIG. 7 is a flow diagram of a method for obtaining a session authentication cookie for an endpoint according to various embodiments. According to various embodiments, process 700 is implemented at least in part by one or more of system 100 of FIG. 1 and/or system 300 of FIG. 3. In some embodiments, process 700 is implemented by an endpoint or a security service client running on an endpoint, such as security service client 310 of FIG. 3.

In some embodiments, process 700 is implemented by an endpoint, such as an endpoint attempting to connect to a cloud service (e.g., one or more servers) that provides other network security services to various network endpoints or security entities. The endpoint may authenticate with the cloud service to obtain access to network resources.

At 705, the system authenticates with a gateway using credentials. For example, an endpoint can authenticate with a gateway using a user identifier (e.g., a username) and a passcode (e.g., a password, a pin, an alphanumeric string, etc.). At 710, the system obtains a PSK from the gateway. For example, after authenticating with the gateway using the credentials, the system obtains the PSK from the gateway. The system may obtain the PSK by sending a getconfig request to the gateway, which generates the PSK and communicates the PSK to the system via a secure communication channel. At 715, the system stores the PSK. The system can store the PSK in association with an identifier for the gateway. In some embodiments, the endpoint stores the PSK in association with a session identifier for the session between the endpoint and the gateway. In some embodiments, the system stores the PSK in an encrypted state. At 720, the system determines whether process 700 is complete. In some embodiments, the system determines process 700 to be complete in response to a determination that authentication of the endpoint has completed, a session between an endpoint and gateway service is terminated, no further endpoints are to be authenticated, no further endpoint login requests are to be processed, an administrator indicates that process 700 is to be paused or stopped, etc. In response to a determination that process 700 is complete, process 700 ends. In response to a determination that process 700 is not complete, process 700 returns to 705.

According to various embodiments, the system dynamically generates a PSK to enhance the security of the IKEv2 authentication process by ensuring that the key is unique and session-specific. The PSK is created in response to a configuration request, such as a getconfig request, received from the endpoint. To generate the PSK, the system can use a cryptographic process that involves a master key and a salt value. This combination ensures that the resulting PSK is sufficiently randomized and difficult to predict, providing a robust level of security against brute force or other attacks aimed at guessing the key.

The generation process is designed to be automated and repeatable within the system, removing the need for manual intervention by administrators, which often introduces vulnerabilities. By dynamically generating PSKs for each session or endpoint, the system avoids the pitfalls of static keys that may be reused across multiple connections. This dynamic approach ensures that even if one PSK is compromised, it does not jeopardize the security of other sessions or endpoints, thereby limiting the potential impact of a breach.

Once the PSK is generated, the system securely transmits it to the endpoint as part of the configuration response to the getconfig request. The delivery process leverages secure communication protocols, such as an encrypted HTTPS connection or a similar method, to ensure that the PSK remains confidential during transit. By transmitting the PSK through a secure channel, the system mitigates the risk of interception or unauthorized access by malicious actors who may attempt to exploit weak or unsecured communication methods.

The endpoint receives the PSK and uses it as part of its subsequent IKEv2 authentication requests. Specifically, the PSK is used to encrypt the payload of the authentication request, which includes critical elements like the session authentication cookie. This encrypted payload is then transmitted back to the system for decryption and validation. By coupling the dynamically generated PSK with session-specific elements, the system ensures that the authentication process is highly secure and resistant to common attack vectors such as replay attacks or key compromise. This approach provides a robust framework for managing secure access to network resources while maintaining flexibility and ease of deployment for enterprise environments.

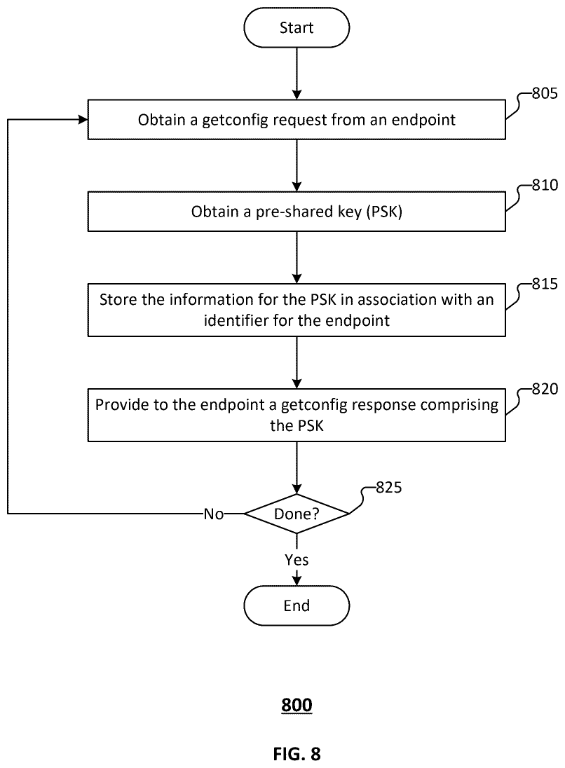

FIG. 8 is a flow diagram of a method for obtaining a pre-shared key (PSK) according to various embodiments. According to various embodiments, process 800 is implemented at least in part by one or more of system 100 of FIG. 1 and/or system 300 of FIG. 3. In some embodiments, process 800 is implemented by a firewall or gateway, such as gateway service 170 of system 100 and/or gateway service 330 of FIG. 3.

In some embodiments, process 800 is implemented by a cloud service (e.g., one or more servers) that provides other network security services to various network endpoints or security entities. For example, the system may implement process 800 to authenticate endpoints such as in connection with exposing network assets to the endpoint.

At 805, the system obtains a getconfig request from an endpoint. At 810, the system obtains a PSK. For example, the system generates the PSK based at least in part on a locally stored master key and a cryptographic salt. In some embodiments, the system implements a predefined KDF to generate the PSK based at least in part on the master key and a cryptographic salt generated for the endpoint. The cryptographic salt may be obtained based at least in part on a unique identifier associated with the endpoint, such as a timestamp for a connection between the endpoint and the gateway (e.g., a timestamp of when the endpoint authenticated using user credentials, a timestamp associated with the receipt of a getconfig request from the endpoint, a timestamp of when the session between the endpoint and the gateway began, etc.). At 815, the system stores the PSK in association with an identifier for the endpoint. The identifier for the endpoint may be an identifier that uniquely identifies the endpoint, for example, at least with respect to other endpoints connected to the endpoint. In some embodiments, the system stores the PSK in association with a virtual IP address assigned to the endpoint or otherwise associated with the connection between the endpoint and the system (e.g., the gateway). At 820, the system provides to the endpoint a getconfig response comprising the PSK. At 825, the system determines whether process 800 is complete. In some embodiments, the system determines process 800 to be complete in response to a determination that authentication of the endpoint has completed, a session between an endpoint and gateway service is terminated, no further endpoints are to be authenticated, no further PSKs are to be generated, no further endpoint login requests are to be processed, an administrator indicates that process 800 is to be paused or stopped, etc. In response to a determination that process 800 is complete, process 800 ends. In response to a determination that process 800 is not complete, process 800 returns to 805.

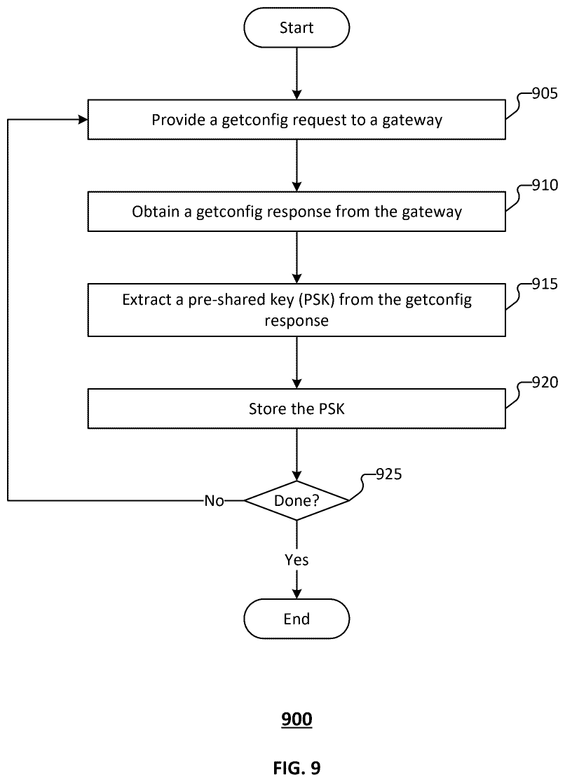

FIG. 9 is a flow diagram of a method for obtaining a pre-shared key (PSK) according to various embodiments. According to various embodiments, process 900 is implemented at least in part by one or more of system 100 of FIG. 1 and/or system 300 of FIG. 3. In some embodiments, process 900 is implemented by an endpoint or a security service client running on an endpoint, such as security service client 310 of FIG. 3.

In some embodiments, process 900 is implemented by an endpoint, such as an endpoint attempting to connect to a cloud service (e.g., one or more servers) that provides other network security services to various network endpoints or security entities. The endpoint may authenticate with the cloud service to obtain access to network resources.

At 905, the system provides a getconfig request to a gateway. At 910, the system obtains a getconfig response from the gateway. At 915, the system extracts a PSK from the getconfig response. At 920, the system stores the PSK. At 925, the system determines whether process 900 is complete. In some embodiments, the system determines process 900 to be complete in response to a determination that authentication of the endpoint has completed, no further IKEv2 authentications are to be performed with the gateway, no further network resources are to be accessed by the endpoint, a session between the endpoint and the gateway has ended, an administrator indicates that process 900 is to be paused or stopped, etc. In response to a determination that process 900 is complete, process 900 ends. In response to a determination that process 900 is not complete, process 900 returns to 905.

To perform IKEv2 authentication, the endpoint initiates a request by preparing a payload that includes authentication data, such as the session authentication cookie. The session authentication cookie is a unique identifier previously assigned to the endpoint during a secure login process with the system. By including the session authentication cookie in the authentication payload, the endpoint ensures that the authentication process is tied to a specific session and incorporates an additional layer of security to validate its legitimacy.

Before transmitting the payload, the endpoint encrypts it using the PSK that was securely received from the system during the configuration process. The PSK, generated dynamically by the system and transmitted via a secure channel, serves as a critical component in protecting the confidentiality and integrity of the payload. Encryption of the payload ensures that the session authentication cookie and any other sensitive information included in the request cannot be intercepted or tampered with by malicious actors during transmission.

The encryption process utilizes cryptographic algorithms compatible with the IKEv2 protocol, ensuring secure and efficient encryption of the payload. By encrypting the session authentication cookie and other authentication data, the endpoint prevents unauthorized access or manipulation of the information in transit. This encryption also ensures that only the intended recipient, the system, which holds the corresponding decryption key (derived from the PSK), can access and validate the contents of the payload.

Once the payload is encrypted, the endpoint encapsulates it within the IKEv2 authentication request and transmits the request to the system. The system receives the IKEv2 authentication request and uses its server-side stored PSK (or a contemporaneously generated PSK based on a server-side salt stored in association with the endpoint and/or session) to decrypt the payload. Upon successful decryption, the system extracts the session authentication cookie and validates it by comparing it with the corresponding server-side stored session authentication cookie. If the session authentication cookie is valid and unexpired, and the payload is correctly decrypted, the system authenticates the endpoint and grants access to the requested resources.

This process ensures a secure and efficient mechanism for authenticating endpoints, leveraging dynamic PSK generation and session-specific cookies to mitigate risks associated with static keys and replay attacks. By encrypting the payload with the PSK, the endpoint safeguards the authentication request, maintaining the confidentiality and integrity of the session while facilitating robust network access control.

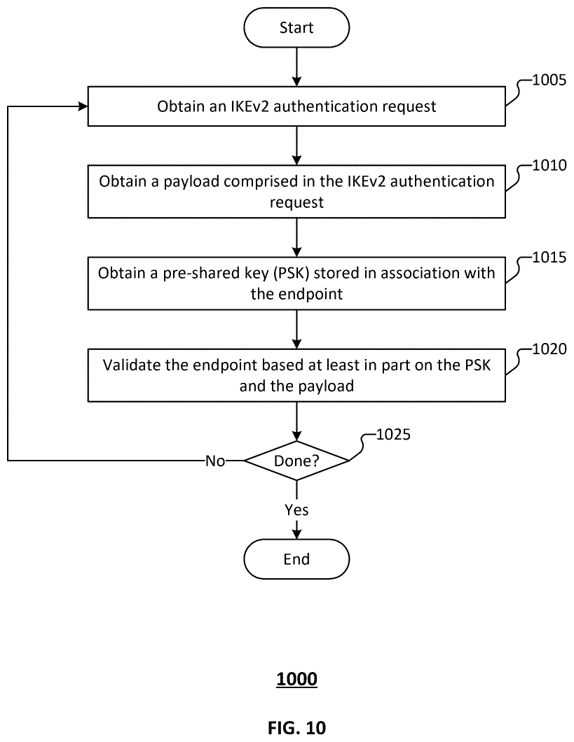

FIG. 10 is a flow diagram of a method for validating an endpoint in connection with an Internet Key Exchange version 2 (IKEv2 ) authentication according to various embodiments. According to various embodiments, process 1000 is implemented at least in part by one or more of system 100 of FIG. 1 and/or system 300 of FIG. 3. In some embodiments, process 1000 is implemented by a firewall or gateway, such as gateway service 170 of system 100 and/or gateway service 330 of FIG. 3.

In some embodiments, process 1000 is implemented by a cloud service (e.g., one or more servers) that provides other network security services to various network endpoints or security entities. For example, the system may implement process 1000 to authenticate endpoints such as in connection with exposing network assets to the endpoint.

According to various embodiments, when the system receives an IKEv2 authentication request from an endpoint, it begins the authentication process by decrypting the payload of the request. The payload, encrypted by the endpoint using the PSK, contains critical authentication data, including the session authentication cookie. The system retrieves the server-side stored PSK (or a contemporaneously generated PSK using a server-side stored salt and master key), which corresponds to the endpoint or the session, and uses it to decrypt the received payload. This decryption step ensures that the contents of the payload can only be accessed by the system and confirms the integrity of the transmitted data.

After successfully decrypting the payload, the system extracts the session authentication cookie included by the endpoint. This session authentication cookie is a unique identifier that the system previously assigned to the endpoint during a secure login process. To validate the cookie, the system compares the extracted value with a server-side stored session authentication cookie associated with the endpoint or the specific session. The comparison ensures that the session authentication cookie matches the expected value and has not been tampered with during transmission.

In addition to verifying the match, the system checks the validity of the session authentication cookie by ensuring it has not expired. The session authentication cookie may have a predefined validity period, and the system evaluates whether the cookie is still within this timeframe. This step ensures that even if a session authentication cookie were intercepted, it could not be reused beyond its intended duration, protecting the system against replay attacks.

If the decryption of the payload is successful and the session authentication cookie is both valid and matches the stored reference, the system authenticates the endpoint. This successful authentication grants the endpoint access to the requested network resources or assets behind the system. Conversely, if the payload cannot be decrypted, the session authentication cookie does not match, or the cookie is expired, the system denies the authentication request, effectively blocking the endpoint from accessing protected resources.

This process ensures a robust authentication mechanism that combines dynamic key management and session-specific validation. By utilizing the PSK to decrypt the payload and validating the session authentication cookie, the system provides a secure method for confirming the identity and legitimacy of endpoints seeking access to critical network assets. This layered approach mitigates risks associated with static credentials, unauthorized access, and replay attacks, delivering a highly secure and scalable solution for enterprise environments.

Returning to the example shown in FIG. 10, at 1005, the system obtains an IKEv2 authentication request. At 1010, the system obtains a payload comprised in the IKEv2 authentication request. At 1015, the system obtains a PSK stored in association with the endpoint. At 1020, the system validates the endpoint based at least in part on the PSK and the payload. At 1025, the system determines whether process 1000 is complete. In some embodiments, the system determines process 1000 to be complete in response to a determination that authentication of the endpoint has completed, a session between an endpoint and gateway service is terminated, no further endpoints are to be authenticated, an administrator indicates that process 1000 is to be paused or stopped, etc. In response to a determination that process 1000 is complete, process 1000 ends. In response to a determination that process 1000 is not complete, process 1000 returns to 1005.

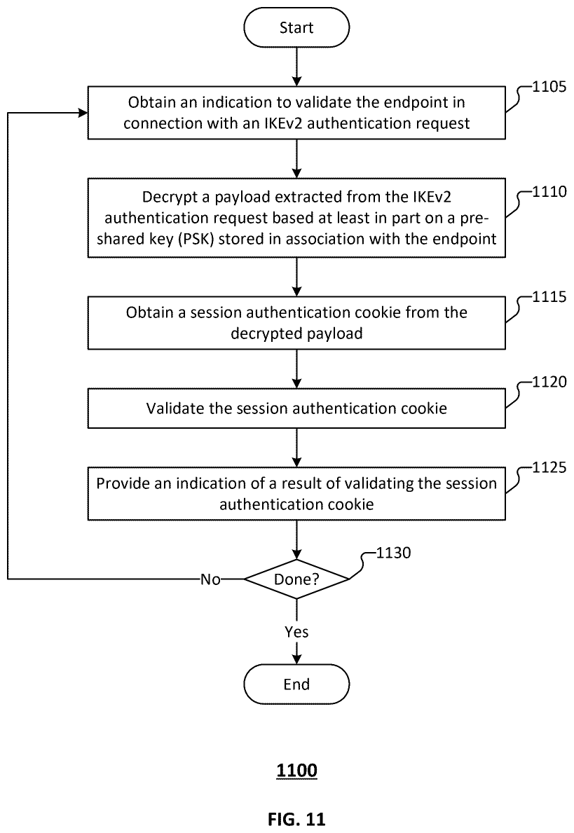

FIG. 11 is a flow diagram of a method for validating an endpoint in connection with an Internet Key Exchange version 2 (IKEv2) authentication according to various embodiments. According to various embodiments, process 1100 is implemented at least in part by one or more of system 100 of FIG. 1 and/or system 300 of FIG. 3. In some embodiments, process 1100 is implemented by an endpoint or a security service client running on an endpoint, such as security service client 310 of FIG. 3.

In some embodiments, process 1100 is implemented by a cloud service (e.g., one or more servers) that provides other network security services to various network endpoints or security entities. For example, the system may implement process 1100 to authenticate endpoints such as in connection with exposing network assets to the endpoint.

At 1105, the system obtains an indication to validate the endpoint in connection with an IKEv2 authentication request. At 1110, the system decrypts a payload extracted from the IKEv2 authentication request based at least in part on a PSK stored in association with the endpoint. At 1115, the system obtains a session authentication cookie from the decrypted payload. At 1120, the system validates the session authentication cookie. At 1125, the system provides an indication of a result of validating the session authentication cookie. At 1130, the system determines whether process 1100 is complete. In some embodiments, the system determines process 1100 to be complete in response to a determination that authentication of the endpoint has completed, a session between an endpoint and gateway service is terminated, no further endpoints are to be authenticated, an administrator indicates that process 1100 is to be paused or stopped, etc. In response to a determination that process 1100 is complete, process 1100 ends. In response to a determination that process 1100 is not complete, process 1100 returns to 1105.

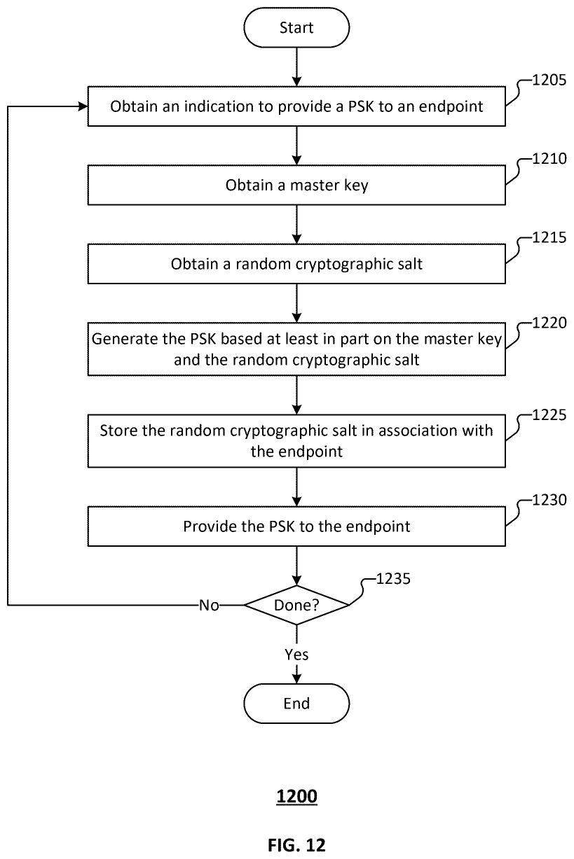

FIG. 12 is a flow diagram of a method for validating an endpoint in connection with an Internet Key Exchange version 2 (IKEv2 ) authentication according to various embodiments. According to various embodiments, process 1200 is implemented at least in part by one or more of system 100 of FIG. 1 and/or system 300 of FIG. 3. In some embodiments, process 1200 is implemented by an endpoint or a security service client running on an endpoint, such as security service client 310 of FIG. 3.

In some embodiments, process 1200 is implemented by a cloud service (e.g., one or more servers) that provides other network security services to various network endpoints or security entities. For example, the system may implement process 1200 to authenticate endpoints such as in connection with exposing network assets to the endpoint.

At 1205, the system obtains an indication to provide a PSK to an endpoint. For example, the system receives a getconfig message from the endpoint and determines to generate and provide a PSK to the endpoint (e.g., for the endpoint to use in subsequent IKEv2 authentications). In some embodiments, a new PSK is generated and provided to the endpoint for each session between the endpoint and the system (e.g., the gateway). At 1210, the system obtains a master key. The master key may be a pre-defined key that is stored locally at the system (e.g., the gateway). At 1215, the system obtains a random cryptographic salt. In some embodiments, the cryptographic salt is a unique number for the endpoint. As an example, the random cryptographic salt is generated based on a timestamp associated with a connection between an endpoint and the gateway (e.g., a timestamp of when the endpoint authenticated using user credentials, a timestamp associated with the receipt of a getconfig request from the endpoint, a timestamp of when the session between the endpoint and the gateway began, etc.).

In some embodiments, the system securely stores the cryptographic salt associated with each endpoint to ensure consistent and reliable key regeneration during the authentication process. Upon generating the cryptographic salt for an endpoint, the system stores it in association with the endpoint's virtual IP address, which is assigned during the session establishment with the gateway. This mapping allows the system to efficiently retrieve the appropriate cryptographic salt when needed, ensuring that the correct parameters are used to regenerate the PSK for subsequent authentication requests. The virtual IP address serves as a unique identifier within the system, providing an effective way to map the cryptographic salt to the specific endpoint.

To facilitate efficient storage and retrieval, the system can be configured to maintain a locally stored mapping of virtual IP addresses to their corresponding cryptographic salts. This mapping is securely stored within the gateway to prevent unauthorized access and tampering. By maintaining this local repository, the system ensures that authentication operations can be performed rapidly without the need for external lookups or additional processing delays. This design enhances the efficiency of the authentication process while maintaining a high level of security by keeping critical cryptographic data within the trusted environment of the gateway.

In some embodiments, when the system receives an IKEv2 authentication request from an endpoint, it retrieves the stored cryptographic salt to verify the request. The system determines the virtual IP address of the endpoint based on the information contained within the authentication request and then performs a lookup in the locally stored mapping to obtain the corresponding cryptographic salt. This retrieval process can ensure that the system can accurately regenerate the PSK using the same inputs that were used during the initial key generation.

Using the retrieved cryptographic salt and the master key stored securely at the gateway, the system regenerates the PSK by applying the predefined KDF. This regenerated PSK is then used to decrypt the payload of the IKEv2 authentication request received from the endpoint. By validating the decrypted payload against the expected authentication parameters, the system can determine whether the endpoint has used the correct PSK and whether the authentication request is legitimate. If the decrypted contents are valid and match the expected values, the endpoint is authenticated; otherwise, the authentication request is denied.

The technique for generating and maintaining cryptographic salts in connection with IKEv2 authentication ensures a high level of security and consistency in the authentication process by eliminating the need to transmit sensitive cryptographic salts over the network. Instead, the system may rely on its secure storage and retrieval mechanisms to handle the authentication process locally. By mapping the cryptographic salt to the endpoint's virtual IP address, the system provides an efficient and secure means of managing session-specific authentication credentials, helping to prevent unauthorized access while ensuring smooth and reliable endpoint authentication within the network.

Returning to the example shown, at 1220, the system generates the PSK based at least in part on the master key and the random cryptographic salt. In some embodiments, the system implements a key derivation function (KDF) to generate the PSK based at least in part on the master key and the random cryptographic salt. The KDF may be a predefined function implemented by the gateway to generate PSKs for endpoints authenticated therewith. At 1225, the system stores the random cryptographic salt in association with the endpoint. As an example, the random cryptographic salt in association with an identifier for the endpoint. The identifier for the endpoint may be a virtual IP address associated with the endpoint (e.g., the virtual IP address for the session between the endpoint and the gateway). At 1230, the system provides the PSK to the endpoint. At 1235, the system determines whether process 1200 is complete. In some embodiments, the system determines process 1200 to be complete in response to a determination that no further IKEv2 authentication is to be performed, no further PSKs are to be provided to endpoints, an administrator indicates that process 1200 is to be paused or stopped, etc. In response to a determination that process 1200 is complete, process 1200 ends. In response to a determination that process 1200 is not complete, process 1200 returns to 1205.

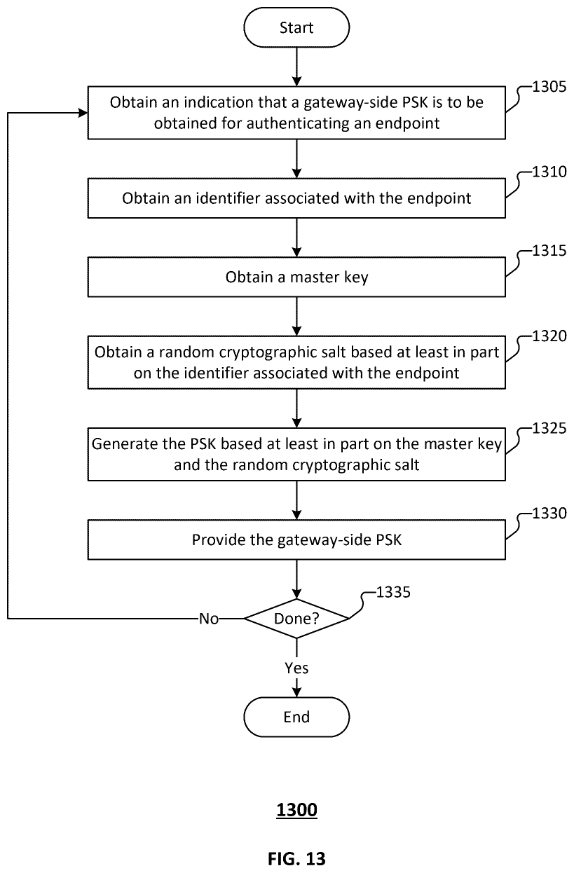

FIG. 13 is a flow diagram of a method for obtaining a PSK to validate an endpoint in connection with an IKEv2 authentication according to various embodiments. According to various embodiments, process 1300 is implemented at least in part by one or more of system 100 of FIG. 1 and/or system 300 of FIG. 3. In some embodiments, process 1300 is implemented by an endpoint or a security service client running on an endpoint, such as security service client 310 of FIG. 3.

In some embodiments, process 1300 is implemented by a cloud service (e.g., one or more servers) that provides other network security services to various network endpoints or security entities. For example, the system may implement process 1300 to authenticate endpoints such as in connection with exposing network assets to the endpoint.

At 1305, the system obtains an indication that a gateway-side PSK is to be obtained for authenticating an endpoint. The system may obtain the indication in response to determining that the system (e.g., the gateway) is to perform an IKEv2 authentication for an endpoint, such as in response to obtaining a IKEv2 authentication requestion. At 1310, the system obtains an identifier associated with the endpoint. At 1315, the system obtains a master key. At 1320, the system obtains a random cryptographic salt based at least in part on the identifier associated with the endpoint. For example, the system queries a mapping of endpoint identifiers to cryptographic salts to obtain the cryptographic salt for the endpoint for which the IKEv2 is to be performed. The identifier associated with the endpoint may be a unique identifier for the endpoint, such as a virtual IP address for the endpoint in connection with the session between the endpoint and the system (e.g., the gateway). At 1325, the system generates the PSK based at least in part on the master key and the random cryptographic salt. For example, the system generates the PSK by implementing a KDF based on the master key and the random cryptographic salt. At 1330, the system provides the gateway-side PSK. The system may provide the gateway-side PSK to the system or service that invoked process 1300. For example, the system provides the gateway-side PSK to a service performing the IKEv2 authentication (e.g., for use in decrypting a blob of the IKEv2 authentication request, such as the authentication payload). At 1335, the system determines whether process 1300 is complete. In some embodiments, the system determines process 1300 to be complete in response to a determination that no further endpoints are to be authenticated, no further IKEv2 authentication requests are to be processed, no further IKEv2 authentication is to be performed, an administrator indicates that process 1300 is to be paused or stopped, etc. In response to a determination that process 1300 is complete, process 1300 ends. In response to a determination that process 1300 is not complete, process 1300 returns to 1305.

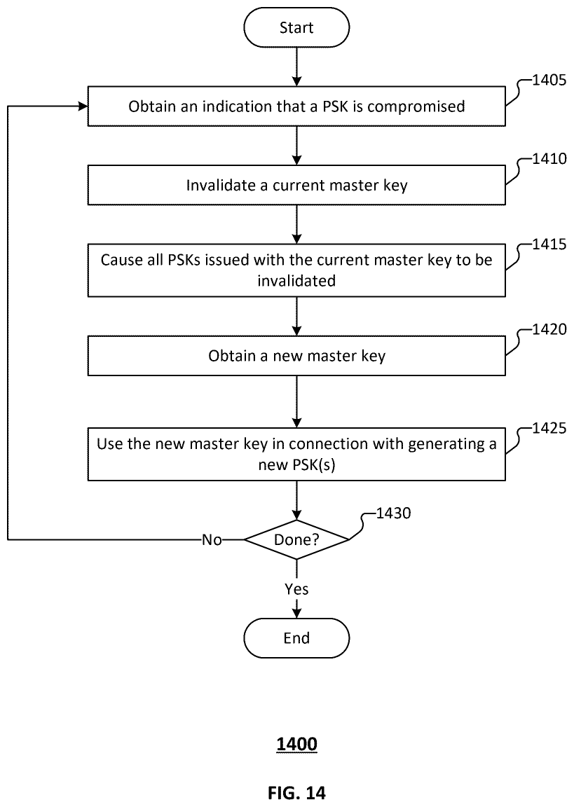

FIG. 14 is a flow diagram of a method for obtaining a new PSK according to various embodiments. According to various embodiments, process 1400 is implemented at least in part by one or more of system 100 of FIG. 1 and/or system 300 of FIG. 3. In some embodiments, process 1400 is implemented by an endpoint or a security service client running on an endpoint, such as security service client 310 of FIG. 3.

In some embodiments, process 1400 is implemented by a cloud service (e.g., one or more servers) that provides other network security services to various network endpoints or security entities. For example, the system may implement process 1400 to authenticate endpoints such as in connection with exposing network assets to the endpoint.

According to various embodiments the system determines that a PSK has been compromised, it takes immediate or proactive action to protect the security of the network and its resources. This determination may be based on detecting suspicious or abnormal behavior from an endpoint, such as repeated failed authentication attempts, unusual access patterns, or deviations from expected communication protocols. Such behaviors could indicate that an unauthorized entity has obtained the PSK and is attempting to use it to gain access to the system. To mitigate potential security threats, the system responds by invalidating the master key from which the compromised PSK was derived.

Upon invalidating the master key, the system ensures that all PSKs previously generated using that master key are also invalidated. This prevents any further use of the compromised PSKs by potentially unauthorized endpoints. In some embodiments, the system initiates a process to generate (e.g., obtain from an administrator) a new master key and generate corresponding PSKs to replace the invalidated credentials. By doing so, the system effectively revokes access for any endpoints attempting to authenticate using the old, potentially compromised PSKs, ensuring that only endpoints equipped with newly issued secure credentials can continue accessing network resources.

In cases where an endpoint attempts to authenticate using a PSK derived from the now-invalidated master key, the system identifies the PSK as invalid during the authentication process. For example, when the system retrieves the updated master key and uses it to regenerate the PSK to decrypt the authentication payload, the decryption process will fail. This failure occurs because the endpoint, still using the outdated PSK, will have encrypted the authentication payload with a different key than the one the system now recognizes. The mismatch between the PSK used for encryption by the endpoint and the PSK used for decryption by the system results in a failed authentication attempt, prompting the system to deny access to the endpoint.

By implementing this technique, the system can ensure that endpoints relying on compromised credentials are prevented from establishing a secure session, thereby containing potential security breaches. This mechanism allows the system to dynamically respond to security threats without disrupting the overall functionality of the network. Endpoints affected by the invalidation of the master key are triggered/required to undergo a reauthentication process, during which they obtain new credentials securely provided by the system.

The invalidation and regeneration of master keys and PSKs provide a robust defense against unauthorized access and credential compromise. By continuously monitoring endpoint behavior and proactively addressing security risks, the system can enhance the resilience of the authentication process. For example, this approach ensures that compromised credentials do not pose a persistent threat to network security while maintaining operational efficiency for legitimate users.

Returning to the example shown, at 1405, the system obtains an indication that a PSK is compromised. As an example, the system may determine that the PSK is compromised based on a determination that authentication using the PSK for the endpoint fails. As another example, the system may determine that the PSK is compromised in response to determining that an endpoint to which the PSK is assigned is behaving suspiciously or unusually. At 1410, the system invalidates a current master key. In response to determining that the PSK is compromised, the system invalidates the current master key to prevent the master key from being used to provide further PSKs or in connection with subsequent IKEv2 authentications. At 1415, the system causes all PSKs issued with the current master key to be invalidated. In response to invalidating the master key and all PSKs issued with the now invalidated master key, the system can trigger new PSKs to be generated for the invalided PSKs. For example, the system can trigger the corresponding endpoint(s) to obtain a new PSK such as by reconnecting or otherwise reauthenticating with the system. At 1420, the system obtains a new master key. The system can obtain a master key from an administrator or from another system or service that manages master keys for various gateways within the network. At 1425, the system uses the new master key in connection with generating a new PSK(s). At 1430, the system determines whether process 1400 is complete. In some embodiments, the system determines process 1400 to be complete in response to a determination that no further endpoints are to be authenticated, no further PSKs are compromised, no further IKEv2 authentication is to be performed, an administrator indicates that process 1400 is to be paused or stopped, etc. In response to a determination that process 1400 is complete, process 1400 ends. In response to a determination that process 1400 is not complete, process 1400 returns to 1405.

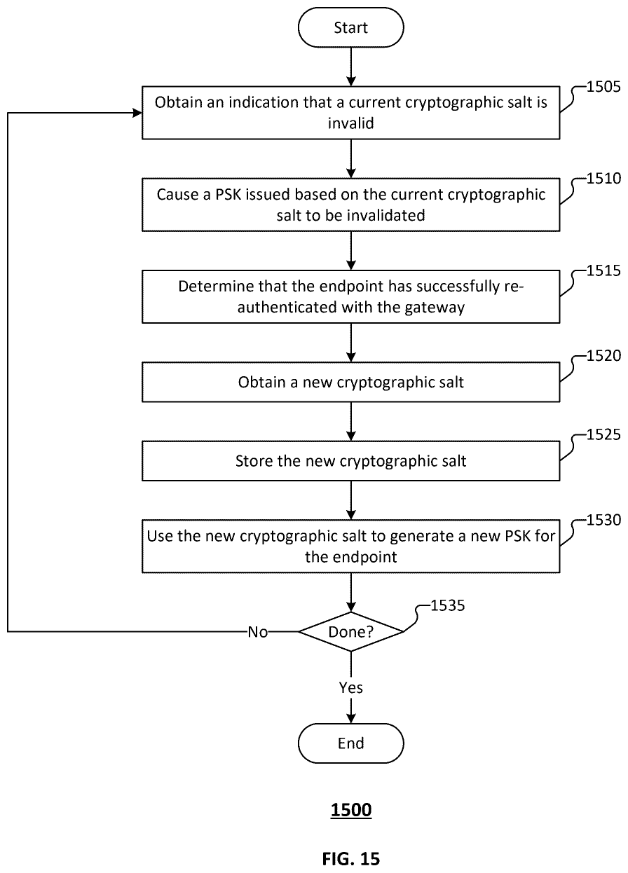

FIG. 15 is a flow diagram of a method for obtaining a new PSK according to various embodiments. According to various embodiments, process 1500 is implemented at least in part by one or more of system 100 of FIG. 1 and/or system 300 of FIG. 3. In some embodiments, process 1500 is implemented by an endpoint or a security service client running on an endpoint, such as security service client 310 of FIG. 3.

In some embodiments, process 1500 is implemented by a cloud service (e.g., one or more servers) that provides other network security services to various network endpoints or security entities. For example, the system may implement process 1500 to authenticate endpoints such as in connection with exposing network assets to the endpoint.

According to various embodiments, if the system determines that the cryptographic salt associated with an endpoint is invalid, the system takes immediate or proactive steps to ensure the security of the session by invalidating the corresponding PSK that was generated using that cryptographic salt. The invalidation of the PSK prevents the endpoint from using outdated or compromised credentials to access the system, thereby maintaining the integrity of the authentication process. Once the system detects an invalid cryptographic salt, can trigger the generation of a new cryptographic salt and PSK, ensuring that future authentication requests are processed with updated and secure credentials.

In such implementations, the system may require the endpoint to reauthenticate using its original credentials, such as a username and password. This reauthentication process allows the gateway to establish a fresh session with the endpoint and generate a new cryptographic salt and PSK accordingly. By enforcing reauthentication, the system ensures that the endpoint's access is re-validated, mitigating potential security risks that could arise from the continued use of expired or compromised session credentials. The new session credentials are securely transmitted to the endpoint, allowing it to resume communication with the gateway under a newly secured session.

In some implementations, the cryptographic salt is configured with a predefined expiration period. The system monitors the validity of the cryptographic salt and determines its expiration based on the established time limits. Once the expiration threshold is reached, the system proactively marks the cryptographic salt as invalid, triggering the generation of new session credentials for the endpoint. This proactive management of cryptographic salt expiration helps ensure that authentication credentials are refreshed periodically, reducing the likelihood of unauthorized access due to stale security parameters.

The system may also determine that the cryptographic salt has become invalid when it attempts to retrieve the salt during the PSK regeneration process (e.g., when performing an IKEv2 authentication). For example, when an endpoint sends an IKEv2 authentication request, the gateway retrieves the stored cryptographic salt to regenerate the PSK and validate the encrypted authentication payload. If the salt is determined to be expired or otherwise invalid at this stage, the system will reject the authentication attempt and initiate the process of generating a new salt and PSK. This dynamic validation approach ensures that outdated cryptographic salts do not compromise the integrity of ongoing authentication processes.

By incorporating mechanisms to detect and respond to invalid cryptographic salts, the system can maintain a high level of security and reliability in managing endpoint authentication. The ability to trigger reauthentication and generate fresh session credentials enhances the system's resilience against security threats such as replay attacks and unauthorized access attempts.

Returning to the example shown, at 1505, the system obtains an indication that a current cryptographic salt is invalid. In some embodiments, cryptographic salts have a predefined expiration. The system can deem the cryptographic salt to be invalid upon expiry. As an example, when the system retrieves the cryptographic salt to perform an IKEv2 authentication (e.g., to generate the PSK for decrypting the authentication payload in the IKEv2 authentication request, the system can check to determine whether the cryptographic salt is valid (e.g., is unexpired). At 1510, the system causes a PSK issued based on the current cryptographic salt to be invalidated. The system can trigger the endpoint to obtain a PSK, for example, by triggering the endpoint to begin a new reauthentication with the gateway (e.g., to send a new getconfig request, etc.). At 1515, the system determines that the endpoint has successfully re-authenticated with the gateway. At 1520, the system obtains a new cryptographic salt. At 1525, the system stores the new cryptographic salt. At 1530, the system uses the new cryptographic salt to generate a new PSK for the endpoint. At 1535, the system determines whether process 1500 is complete. In some embodiments, the system determines process 1500 to be complete in response to a determination that no further endpoints are to be authenticated, no further PSKs are to be provided, no further IKEv2 authentication is to be performed, an administrator indicates that process 1500 is to be paused or stopped, etc. In response to a determination that process 1500 is complete, process 1500 ends. In response to a determination that process 1500 is not complete, process 1500 returns to 1505.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
generate a pre-shared key (PSK) based at least in part on a master key and a random cryptographic salt using a key derivation function (KDF); and
validate an endpoint based at least in part on using the PSK, wherein the validation of the endpoint is based at least in part on a determination that the endpoint has previously authenticated with credentials; and
a memory coupled to the one or more processors and configured to provide the one or more processors with instructions.

2. The system of claim 1, wherein the PSK is generated at a secure gateway with which the endpoint is connected.

3. The system of claim 2, wherein the gateway provides the PSK to the endpoint.

4. The system of claim 1, wherein:
the one or more processors are further configured to:
determine that the endpoint has successfully logged into a secure gateway; and
the secure gateway generates the PSK in response to a determination that the endpoint has successfully logged into the secure gateway.

5. The system of claim 1, wherein the KDF is a predefined function.

6. The system of claim 1, wherein validating the endpoint using the PSK comprises:
generating a gateway-side version of the PSK;
using the gateway-side version of the PSK to decrypt information provided by the endpoint; and
in response to determining that the decryption of the information is successful, deeming the PSK used by the endpoint to encrypt the information to be validated.

7. The system of claim 6, wherein the information decrypted using the gateway-side version of the PSK is obtained from a request for authentication using Internet Key Exchange version 2 (IKEv2) protocol.

8. The system of claim 7, wherein the information decrypted using the gateway-side version of the PSK is an authentication payload comprised in the request for authentication.

9. The system of claim 7, wherein generating a gateway-side version of the PSK comprises:
obtaining an identifier associated with the endpoint;
obtaining the random cryptographic salt based at least in part on the identifier for the endpoint;
obtaining the master key; and
generating gateway-side version of the PSK based at least in part on the master key and the random cryptographic salt.

10. The system of claim 9, wherein the identifier for the endpoint is a virtual internet protocol (IP) address associated with the endpoint.

11. The system of claim 10, wherein the virtual IP address is obtained based at least in part on the request for authentication.

12. The system of claim 1, wherein a secure gateway obtains the random cryptographic salt in response to determining that the endpoint has successfully logged into the secure gateway.

13. The system of claim 12, wherein the secure gateway stores the random cryptographic salt in association with an identifier for the endpoint.

14. The system of claim 12, wherein the endpoint logs into the secure gateway using credentials before using the PSK in connection with an IKEv2 authentication with the secure gateway.

15. The system of claim 1, wherein the endpoint is validated based at least in part on the PSK and a session authentication cookie that is assigned to the endpoint for a particular session between the endpoint and a secure gateway.

16. The system of claim 1, wherein the master key is assigned to a secure gateway that validate the endpoint using the PSK.

17. The system of claim 16, wherein the master key is unique for the secure gateway.

18. The system of claim 1, wherein the random cryptographic salt expires after a predefined period of time.

19. The system of claim 18, wherein when the random cryptographic salt expires the endpoint obtains a new PSK for subsequent IKEv2 authentications, and the new PSK is based at least in part on a new random cryptographic salt.

20. The system of claim 1, wherein the random cryptographic salt is obtained based at least in part on (i) a timestamp associated with a connection between the endpoint and a secure gateway, and (ii) a random number.

21. The system of claim 1, wherein the random cryptographic salt is obtained based at least in part on (i) a universal unique identifier (UUID) for the endpoint, and (ii) a random number.

22. The system of claim 1, wherein a secure gateway stores the random cryptographic in a key-value format.

23. The system of claim 1, wherein in response to a determination that the PSK is compromised, a secure gateway obtains a new master key to replace the master key used to generate the PSK.

24. The system of claim 23, wherein an obtaining of the new master key triggers all PSKs generated using an initial master key to be invalidated and for a regeneration of PSKs for endpoints connected to the secure gateway.

25. The system of claim 23, wherein the new master key is obtained based at least in part on an administrator configuring the new master key.

26. A method, comprising:
generating a pre-shared key (PSK) based at least in part on a master key and a random cryptographic salt using a key derivation function (KDF); and
validating an endpoint based at least in part on using the PSK, wherein the validation of the endpoint is based at least in part on a determination that the endpoint has previously authenticated with credentials.

27. A computer program product embodied in a non-transitory computer readable medium and comprising computer instructions for:
generating a pre-shared key (PSK) based at least in part on a master key and a random cryptographic salt using a key derivation function (KDF); and
validating an endpoint based at least in part on using the PSK, wherein the validation of the endpoint is based at least in part on a determination that the endpoint has previously authenticated with credentials.
